(19) United States
(12) Patent Application Publication
(10) Pub. No.: US 2004/0246595 A1
(43) Pub. Date: Dec. 9, 2004

(54) Optical imaging system with aberration correcting means

(76) Inventor: Allan David Beach, Christchurch (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/477,693

(22) PCT Filed: May 3, 2002
(86) PCT No.: PCT/NZ02/00085

(30) Foreign Application Priority Data
May 15, 2001 (NZ) 511735
Dec. 10, 2001 (NZ) 516019

(51) Int. Cl. G02B 17/00

(52) U.S. Cl. 359/728

(57) ABSTRACT

An optical system includes a front end (1), a rear end image relay (2), an image transfer means (5) adapted to image the aperture stop of the rear end image relay (2) to a position where it forms the entrance pupil of the optical imaging system, and aberration correcting means (6, 7), including a lens (7) having an aspheric surface (7A) at or adjacent the aperture stop of the rear end image relay (2) and a meniscus lens (6A) to correct for both primary and higher order spherical aberration, the aspheric surface (7A) being sufficiently aspherical that chromatic error introduced by lens (7) cancels at least a major part of chromatic error introduced by the meniscus lens (6). The aberration correcting means may further include a multiple component lens (6C) to also cancel chromatic error. The front and rear ends may include one or more mirrors in different configurations.

### TECHNICAL FIELD

The present invention relates to an optical imaging system and in particular, but not exclusively, to an optical imaging system suitable for use in low light level imaging.

### BACKGROUND

Imaging performance of an optical imaging system can be expressed as some combination of the following parameters:

Numerical Aperture (N.A.) or “speed”—for low-light-level capability;

Field angle—for the biggest picture;

Angular resolution—for the sharpest picture;

Spectral bandpass—for multi-spectral capability;

Pupil diameter—for the highest (appropriate) upper limit of light-gathering power; and

Transmission losses.

The planar nature of solid-state imaging devices dictates the need for flat-field imaging optics; hence, a further desirable characteristic is a flat focal surface.

Also, the limited lateral dimensions of solid state imaging devices relative to those of photographic emulsion substrates, require shorter focal lengths in order to achieve useful field angles. These specifics are in conflict with the characteristics of optical imaging systems with large pupil diameters, because of the ensuing high N.A. values, and the associated difficulties of aberration control and elimination of residual curvature of the focal surface.

Of the many other desirable characteristics, three are of some importance to an elegant solution:

Compactness, for opto-mechanical efficiency.

Rear access to the image surface, for operational adaptability.

Spherical mirrors, for low cost and ease of alignment maintenance.

The problem of aberration control is exacerbated if spherical mirrors are chosen for the system, because of the constraints placed on the available degrees of freedom.

Optical systems for imaging substantially parallel incident light have been produced in many different formats, depending on the performance requirements of the system. For example, some applications require imaging systems with very low aberrations, while others may require a relatively fast imaging system, and others still require a relatively wide useful angular field. Often, these parameters must be traded against each other in order to design a system which best meets the imaging requirements.

The required combinations of the above parameters are dependent on the intended use of the imaging system. For example, spectroscopy of single sources generally does not need a wide field; a sky survey of stellar-like sources does not need speed; and pupil diameter is usually liamited by portability or cost considerations. However, some tasks require reasonable performance of all of the throughput parameters; examples being some remote sensing operations, and sky surveys of extended objects with low surface brightness. In the application of surveillance and border control, for example, a combination of all the above characteristics is required, so that intruders may be identified within a wide area of coverage, despite low light levels. Therefore, it is necessary to minimise the aberrations of the optical system whilst retaining a usefully wide angular field and a high light-gathering power.

### OBJECT OF THE INVENTION

It is an object of the present invention to provide an optical imaging system with a high image quality, thereby overcoming or alleviating problems present in current imaging systems, or that at least provides the public with a useful choice.

Further objects of the present invention may become apparent from the following description.

### SUMMARY OF THE INVENTION

In accordance with a first aspect of the present invention, there is provided an optical imaging system including:

a front end imaging system adapted to produce an intermediate image;

a rear end image relay system including a relay mirror;

an image transfer means adapted to image the aperture stop of the rear end image relay system to a position where it forms the entrance pupil of the optical imaging system;

and aberration correcting means including a lens having an aspheric surface located substantially at or adjacent to the aperture stop of the rear end image relay system and a meniscus lens to correct for both primary and higher order spherical aberration, the aspheric surface being sufficiently aspherical that chromatic error introduced by the lens having an aspheric surface cancels at least a major part of chromatic error introduced by the meniscus lens.

Preferably, the aspheric surface of the lens having an aspheric surface is sufficiently aspheric to cancel substantially all chromatic error introduced by the meniscus lens.

The lens having an aspheric surface may be a low- or zero-powered Schmidt-like lens. As used herein, “Schmidt-like” is intended to mean a substantially flat lens having at least one aspheric surface. A low- or zero-powered “Schmidt-like” lens has little or no net positive or negative focusing power, but changes the shape of the wavefronts passing through it. Such a lens may correct for primary and high order spherical aberrations. The depth of the aspheric surface of the Schmidt-like lens is preferably greater than about 100 microns.

The meniscus lens is suitably a weak negative Maksutov-like meniscus lens. It should be understood that the use of “Maksutov-like” herein is not intended to be limited to describing a traditional Maksutov lens which has a specific relationship between its radii, thickness and refractive index, such that its own residual chromatic aberration is minimized whilst its primary function of correcting spherical aberration remains. Rather, “Maksutov-like” is intended to mean a meniscus lens which does not necessarily have the above specific relationship, but which is used to compensate for at least some spherical aberration generated in the system.

The aberration correcting means preferably further includes a doublet or triplet lens, or other similar multiple-component lens subsystem containing an arbitrary number of elements that are optically in contact (having cemented surfaces) and/or elements that are separated by some finite air space. Preferably, the multiple component lens is adapted to also cancel chromatic error. This may be achieved by using optical glasses of particular relative partial dispersions in both the infra-red and violet portions of the spectrum, allowing the system to be used over a wide visible and near infra-red waveband. Preferably, the multiple component lens is a doublet lens, which is suitably fabricated from PK51 and KzFN2 glasses. Alternatively, the multiple component lens may be a triplet lens which is advantageously fabricated from N-KS, N-KzFS4 and N-F2 glasses. Correctors with more components are not excluded from the scope of this invention, but a higher fabrication cost could result.

The aberration correcting means is advantageously adapted to correct for zonal aberrations. The aberration correcting means may be present in the rear end image relay system.

The rear end image relay system preferably includes a secondary mirror adapted to receive light from the relay mirror. Preferably, the relay mirror is a concave mirror and the secondary mirror is a folding flat mirror.

The optical system may further include a detecting means to detect an image from the rear end image relay system. The detecting means suitably includes an electronic detector.

The system may include a field flattener to adapt the image for detection by a planar detector.

The front end imaging system preferably includes one or more mirrors. In a preferred embodiment, the front end imaging system includes a concave primary mirror. The front end imaging system may include a concave primary mirror and a secondary mirror located so as to reflect light received from the primary mirror.

The system preferably includes a housing and a window to seal the system from the surrounding environment. The window is preferably a meniscus window. In a preferred embodiment, the front end imaging system includes a concave primary mirror and a secondary mirror located so as to reflect light received from the primary mirror, wherein the secondary mirror is formed by a reflective portion on one surface of the meniscus window.

The front end imaging system suitably includes a concave primary mirror and a secondary mirror located so as to reflect light received from the primary mirror, wherein the secondary mirror is mounted to a surface of the window.

The image transfer means is preferably a field lens system. The field lens system may include a single lens. The field lens system includes a multiple component lens.

The system preferably includes a tilted mirror to deflect the focus of part of the optical system.

The front end imaging system and the rear end image relay system are preferably substantially complementary such that selected aberrations introduced into an image by the front end imaging system are at least partly cancelled by substantially like and opposite aberrations introduced by the rear end image relay. Preferably, the front end imaging system and the rear end image relay are adapted so as to be substantially complementary in respect of selected aberrations over field angles up to approximately 2 degrees off-axis.

The parameters of the rear end image relay system may be varied to match the aberrations generated by the front end. Therefore, while the components of the rear end image relay system may stay the same irrespective of the type of front end, their values of radii and thickness may be changed depending on the type of front end. In other words, the particular parameters of the rear end image relay system are generally dependent on the front end.

The radii and separations of the optical system's mirrors may be balanced against each other in such a way as to minimize monochromatic optical aberrations.

Preferably, the rear end image relay system may be adapted to function as a high-speed optical relay.

The front end imaging system may be a spectrograph and the rear end may be a high speed camera. This configuration would be particularly suitable for astronomical work.

Preferably, all surfaces of the optical system's optical imaging components, except one, are substantially spherical.

Preferably, all optical components, except one, are sub-aperture components.

In accordance with a second aspect of the present invention, there is provided a method of imaging substantially parallel incident light onto a detecting means, the method including:

receiving incident light in a front end imaging system;

transferring the image from said front end imaging system to a rear end image relay system having a relay mirror and an aperture stop; and

receiving an image from the rear end image relay system by the detecting means;

wherein the step of transferring the image from said front end imaging system to the rear end image relay system includes passing the light through an aberration correcting means including a lens having an aspheric surface located substantially at or adjacent to the aperture stop of the rear end image relay system and a meniscus lens to correct for both primary and higher order spherical aberration, the aspheric surface being sufficiently aspherical that chromatic error introduced by the lens having an aspheric surface cancels at least a major part of chromatic error introduced by the meniscus lens.

Preferably, the aspheric surface of the lens having an aspheric surface is sufficiently aspheric to cancels substantially all chromatic error introduced by the meniscus lens.

The lens having an aspheric surface is suitably a low- or zero-powered Schmidt-like lens. The depth of the aspheric surface of the Schmidt-like lens is greater than about 100 microns.

The meniscus lens is suitably a weak negative Maksutov-like meniscus lens.

The aberration correcting means further includes a multiple component lens adapted to also cancel chromatic error.

The method advantageously includes, for selected aberrations, introducing like and opposite aberrations in the rear end image relay system to correct for aberrations introduced in the image by the front end imaging system. The method preferably includes introducing said like and opposite aberrations only in relation to field angles up to approximately 2 degrees off-axis.

The method may include balancing the radii and separations of the imaging system's mirrors against each other in such a way as to minimise monochromatic aberration.

The step of transferring the image from said front end imaging system to the rear end image relay system preferably includes imaging the entrance pupil of the front end imaging system onto the aperture stop of the rear end image relay system.

In accordance with a third aspect of the present invention, there is provided an optical imaging system including:

a front end imaging system adapted to produce an intermediate image;

a rear end image relay system including a relay mirror;

an image transfer means adapted to image the aperture stop of the rear end image relay system to a position where it forms the entrance pupil of the optical imaging system;

and aberration correcting means including a lens having an aspheric surface located substantially at or adjacent to the aperture stop of the rear end image relay system and a meniscus lens to correct for both primary and higher order spherical aberration, the aspheric surface being sufficiently aspherical that chromatic error introduced by the lens having an aspheric surface substantially cancels chromatic error introduced by the meniscus lens, the aberration correcting means further including a multiple component lens which is adapted to compensate for chromatic aberration introduced by other refractive components in the optical system.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

FIG. 1: Shows a diagrammatic representation of an optical imaging system according to one preferred embodiment of the present invention, having a pupil diameter of 0.5 m.

FIG. 2: Shows the spot diagram of light distribution at the focal plane from point sources, for a passband of 400-1600 nm, over the 3.5° field.

FIG. 3: Shows the fraction of enclosed energy at various radii from the centroid of each spot.

FIG. 4: Shows a plot of rms spot radius against wavelength within the 400-1600 nm passband.

FIG. 5: Shows a diagrammatic representation of an alternative preferred optical imaging system having a pupil diameter of 0.5 m.

FIG. 6: Shows the spot diagram of light distribution at the focal plane from point sources, for a passband of 430-1000 nm over the 4° field, for the system of FIG. 5.

FIG. 7: Shows the fraction of enclosed energy at various radii from the centroid of each spot, for the system of FIG. 6.

FIG. 8: Shows a diagrammatic representation of an alternative preferred optical imaging system having a pupil diameter of 0.5 m, with the secondary being fabricated as part of a meniscus window.

FIG. 9: Shows a diagrammatic representation of an alternative preferred imaging system having a pupil diameter of 1 m.

FIG. 10: Shows the spot diagram of light distribution at the focal plane from point sources, for a passband of 405-1000 nm over the 2° field, for the system of FIG. 9.

FIG. 11: Shows the fraction of enclosed energy at various radii from the centroid of each spot, for the system of FIG. 9.

FIG. 12: Shows a diagrammatic representation of an alternative preferred optical imaging system having a pupil diameter of 2 m.

FIG. 13: Shows the spot diagram of light distribution at the focal plane from point sources, for a passband of 405-1000 nm over the 1° field, for the system of FIG. 12.

FIG. 14: Shows the fraction of enclosed energy at various radii from the centroid of each spot, for the system of FIG. 12.

FIG. 15: Shows a diagrammatic representation of an alternative preferred optical imaging system having a pupil diameter of 4 m.

FIG. 16: Shows the spot diagram of light distribution at the focal plane from point sources, for a passband of 405-1000 nm over the 0.5° field, for the system of FIG. 15.

FIG. 17: Shows the fraction of enclosed energy at various radii from the centroid of each spot, for the system of FIG. 15.

FIG. 18: Shows a diagrammatic representation of an alternative preferred optical imaging system having a pupil diameter of 8 m.

FIG. 19: Shows the spot diagram of light distribution at the focal plane from point sources, for a passband of 405-1000 nm over the 0.25° field, for the system of FIG. 18.

FIG. 20: Shows the fraction of enclosed energy at various radii from the centroid of each spot, for the system of FIG. 18.

FIG. 21: Shows a diagrammatic representation of an alternative preferred optical imaging system which uses a single mirror rather than a Cassegrain-like front end.

FIG. 22: Shows a diagrammatic representation of an alternative preferred optical imaging system which has a non-Cassegrain-like front end and which is folded by a diagonal mirror to deflect the focus.

FIG. 23: Shows the spot diagram of light distribution at the focal plane from point sources, for a passband of 405-1000 nm over the 1° field, for the system of FIG. 22.

FIG. 24: Shows the fraction of enclosed energy at various radii from the centroid of each spot, for the system of FIG. 22.

FIG. 25: Shows a diagrammatic representation of an alternative preferred optical imaging system which has a non-Cassegrain-like front end including a paraboloid primary mirror.

FIG. 26: Shows the spot diagram of light distribution at the focal plane from point sources, for a passband of 405-1000 nm over the 1° field, for the system of FIG. 25.

FIG. 27 Shows the fraction of enclosed energy at various radii from the centroid of each spot, for the system of FIG. 25.

FIG. 28 Shows a diagrammatic representation of an alternative preferred optical imaging system which does not include a secondary mirror in the rear end.

### DETAILED DESCRIPTION OF THE PREFERRED EMBODIMENTS

A number of the following examples are defined as having a Cassegrain-like front end imaging system. Throughout this specification, the term “Cassegrain-like” has been used in reference to an imaging system for receiving substantially parallel incident light, which includes a concave primary mirror and a convex secondary mirror located relative to the primary mirror so as to precede the focal plane of the primary. The use of “Cassegrain-like” is not intended to be limited to describing solely a traditional Cassegrain format with a paraboloid primary mirror and a hyperboloid secondary mirror.

The optical imaging system of a preferred embodiment of the present invention includes a Cassegrain-like (as hereinbefore defined) front end imaging system, located at the front end of the optical system, to receive light from the objects to be imaged, and a high speed optical relay system, located at the rear end of the optical system to receive light from the front end and image it onto a suitable detecting means. The front end and rear end imaging systems may be designed so that the rear end introduces like and opposite aberrations to the front end, thereby at least partly cancelling selected aberrations. Other aberrations may be corrected using one or more correcting elements.

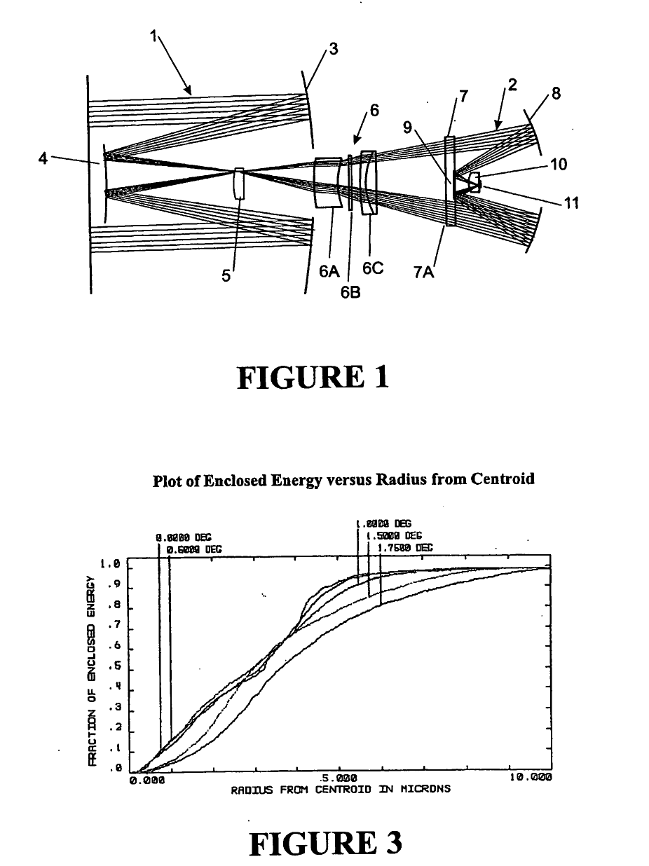

Referring to FIG. 1, a diagrammatic representation of an optical system according to one preferred embodiment of the present invention is shown. For simplicity, only the reflecting and refracting elements of the system are shown, together with the detector. It will be immediately apparent to those skilled in the art that various support structures will be required for the reflecting and refracting elements within the optical system and a baffle may be included to prevent interference from light sources surrounding the imaging system.

An optical imaging system according to the preferred embodiment includes a front end 1 and a rear end 2. The front end 1 includes a primary mirror 3 and a secondary mirror 4, both of which may be spherical to enable high precision fabrication, advantageous alignment characteristics, and reduced cost. The mirrors need not be precisely spherical, but could be modified slightly. Further, other surface shapes, such as hyperboloids or paraboloids may be used if required for specific applications. However, the use of spherical mirrors is the preferred embodiment of the system, which includes appropriate correcting means for spherical aberration, to provide improved image quality.

An image transfer means in the form of a field lens system 5 is located near the image of the front end 1 and has a function to image the aperture stop of the rear end image relay system to a position where it forms the entrance pupil of the optical imaging system.

The field lens system may include one or more lenses, ie may be a single lens or a multiple-component lens. Air-gaps may be provided between the multiple components, or the multiple components may be cemented directly together.

Following the field lens is a corrector group 6, which may be considered to be part of the rear end image relay system. In the embodiment shown in FIG. 1, the corrector group 6 includes a weak negative Maksutov-like (as hereinbefore defined) meniscus lens 6A, a filter 6B and a doublet lens, 6C. While a doublet lens is used in the preferred embodiment, a triplet lens or other multiple component lens subsystem may be used. The doublet lens 6C is constructed using glass of particular relative partial dispersions in both the infra-red and violet portions of the spectrum, thereby allowing the system to be used over a wide visible and near infra-red waveband. Such a construction assists in the correction of chromatic aberration, introduced to the image due to the refractive elements of the optical system. The preferred glasses for the doublet lens are Schott PK51 and KzFN2. Preferred glasses for a triplet lens are Schott N-K5, N-KzFS4 and N-F2.

The system includes an aberration-correcting element, such as a lens 7, which in the preferred embodiment is a zero-powered Schmidt-like (as hereinbefore defined) plate which generates negative spherical aberration. Rather than being zero-powered, the Schmidt-like plate may be low-powered. To avoid introducing high order oblique aberrations such as astigmatism or coma, the front face 7A of the lens 7 is located substantially at the aperture stop of the optical system, which coincides with the entrance pupil of the rear end 2. The front face 7A of the lens 7 is figured to an aspheric shape to compensate for spherical aberration that is introduced by the spherical mirrors of the front end 1 and rear end 2. The lens 7 may also be used to correct for zonal aberrations in the image. The aspheric refractive surface can operate almost equally at all field angles. The front face 7A is sufficiently aspheric such that the chromatic error introduced by the Schmidt-like plate substantially cancels the chromatic error introduced by the Maksutov-like meniscus lens. The depth of the aspheric surface of the Schmidt-like plate is greater than about 100 microns for the examples given, although different strength correctors may be used depending on requirements.

It will be appreciated by those skilled in the art that other correcting elements may be implemented in various forms other than through a lens located substantially at the aperture stop of the system. These may include alternative and/or additional refractive or reflective components located at various positions. The positioning of the lens 7 at the aperture stop is the preferred embodiment to avoid further aberrations being introduced by the correcting lens system.

The rear end 2 includes a relay mirror 8 which is preferably spherical and a folding flat mirror 9. Again, the relay mirror need not be precisely spherical, and could be modified slightly. Further, other surface shapes such as hyperboloids or paraboloids may be used if required for specific application. Folding flat mirror 9 also functions as the central obscuration of the optical system. The folding flat 9 is attached or unitary with the lens 7.

After the rear end 2 receives an image at the field lens system 5, this image is re-imaged by the relay mirror 8 and folding flat mirror 9 to form an image on a detector 10. A field flattener 11 may be provided in the optical path immediately preceding the detector 10 in order to adapt the image to be suitable for detection by a planar imaging device. An air gap is provided between the field flattener and the detector to prevent damage due to contact between the two.

The detector 10 may be any suitable detector, but it is envisaged that the optical system has particular application to electronic detectors.

A key feature of the optical system is its ability to be designed so that aberrations introduced by the front end 1 are at least partly cancelled by introducing equal and opposite aberrations in the rear end 2 and vice versa In particular, the meniscus/plate combination provides simultaneous control of spherical aberration without introducing significant spherochromatic aberration, allowing the optical system to maintain good image definition across a wide range of wavelengths.

It will be appreciated by those skilled in the art that the required curvature, relative locations and any aspheric surface of the primary and secondary mirrors of the front end 1 and rear end 2 may be optimally computed using an optimisation algorithm constrained to negate specific aberrations, such as coma and astigmatism introduced by the system's optical components.

Further aberrations, such as high order spherical aberration, which occurs when substantially spherical mirrors are used, are corrected by other components within the system, particularly the aspheric surface of the front face 7A of the lens 7.

### EXAMPLE SYSTEM ONE

### 0.5 m Pupil Diameter System

Table 1 shows an example optical imaging system having the layout of FIG. 1. The radius and curvature of each surface, thickness (or distance to the next surface), element type and element diameter are shown in Table 1. The design in this example was created to provide a field angle of 3.5°, a speed of F/0.75 and a passband of 400-1600 nm.

TABLE 1
0.5 m PUPIL DIAMETER

| | | | | | Diameter |
|---|---|---|---|---|---|
| Surface | Comment | Radius mm | Thickness mm | Glass | mm |
| 1 | Primary Mirror 3 | −1311.500 | −462.00 | MIRROR | 500 |
| 2 | Secondary Mirror 4 | −1093.090 | 285.00 | MIRROR | 178 |
| 3 | Field Lens 5 | 223.252 | 20.00 | BK7 | 70 |
| 4 | | Infinity | 160.21 | | 70 |
| 5 | Meniscus 6A | 343.723 | 50.00 | SK16 | 110 |
| 6 | | 153.212 | 23.47 | | 110 |
| 7 | Filter 6B | Infinity | 5.00 | BK7 | 120 |
| 8 | | Infinity | 20.50 | | 120 |
| 9 | Colour Corrector 6C | 538.693 | 12.00 | N-PK51 | 140 |
| 10 | | 153.212 | 23.00 | KZFN2 | 140 |
| 11 | | Infinity | 151.47 | | 140 |
| 12 | Aspheric surface & | Infinity | 20.00 | BK7 | 197 |
| | Stop 7A | | | | |
| 13 | | Infinity | 0.00 | | 200 |
| 14 | Central Obscuration 9 | Infinity | 192.20 | | 86 |
| 15 | Relay Mirror 8 | −343.723 | −192.20 | MIRROR | 320 |
| 16 | Folding Flat 9 | Infinity | 30.00 | MIRROR | 86 |
| 17 | Field Flattener 10 | 73.310 | 22.63 | BK7 | 44 |
| 18 | | Infinity | 1.50 | | 44 |
| 19 | Image 11 | Infinity | | | 18.4 |

Asphere on Surface 12
Coeff on r 2: 8.331e−005
Coeff on r 4: −1.029e−008
Coeff on r 6: 1.932e−013
Coeff on r 8: −1.818e−018
Spectral Passband: 400-1600 nm
Entrance Pupil Diameter: 422 mm
Focal Length: 300 mm
Image Space F/#: F/0.71
Working F/#: F/0.76
Central Obscuration: 22%

Also shown in Table 1 are the aspheric coefficients for the front face of lens 7. The aspheric coefficients of the standard asphere function z, are shown in equation 1. For this system, an even asphere was used. Only the first four coefficients were required to meet the design specifications of the system.

$$Z = \frac{c {r}^{2}}{1 + √ ( 1 - ( 1 + k ) {c}^{2} {r}^{2} )} + ( A1 ) {r}^{2} + ( A2 ) {r}^{4} + ( A3 ) {r}^{6} + ( A4 ) {r}^{8} + … \qquad equation 1$$

In the above equation “Z” is the axial distance, “c” is the curvature of the surface, “r” is the radius of the zone, and “k” is the conic constant

The focusing power of the preferred optical system resides in the spherical mirrors, avoiding the major chromatic aberrations associated with powered refractive components.

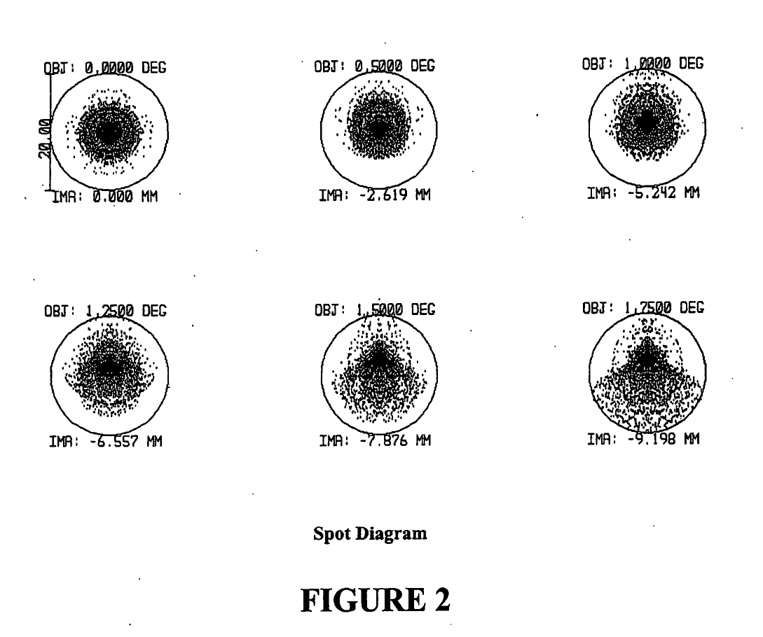

FIG. 2 shows the spot diagram of light distribution at the focal plane from point sources, for a passband of 400-1600 nm, over the 3.5° field angle. The spot diagrams show the absence of chromatic aberration, even with a 4:1 ratio of wavelengths.

FIG. 3 illustrates the fraction of enclosed energy at various radii from the centroid of each spot. The concentration of image energy is maintained at significantly large off-axis angles.

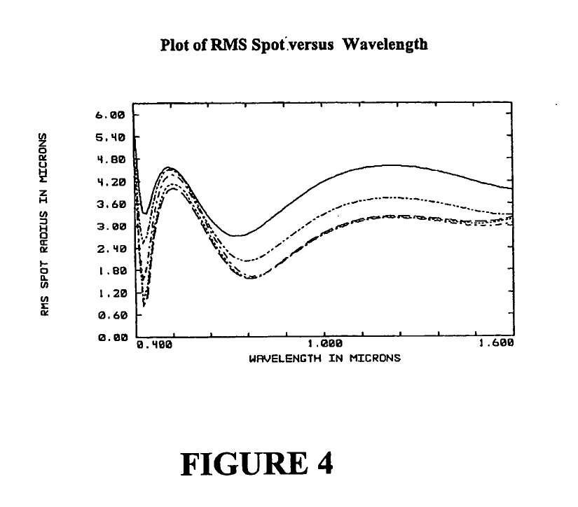

FIG. 4 is a plot of rms spot radius against wavelength within the 400-1600 nm passband, showing stability of the spot radius with wavelength variation over the passband.

The high speed of the rear end image relay system creates an overall optical system with an optical speed faster than that of similar optical imaging systems. The final image has a speed substantially greater than that of the Cassegrain-like front end. The optical system of the present invention may be used to image incident light into small focal spots over a usefully large field angle, while maintaining a high speed and broad spectral passband. The system is also scalable to a very large size. The optical imaging system described herein achieves a unique combination of high speed, high spectral passband and a relatively high field angle.

A feature of the rear end relay format is that the correction optics can have a diameter significantly smaller than that of the entrance pupil of the system, enabling the use of specialized glasses for aberration control even though the entrance pupil may be relatively large.

Further, in the preferred embodiment only one component, the spherical primary mirror, is full aperture diameter, resulting in cost advantages. The system is relatively compact, enabling a rigid and easily mounted optomechanical assembly.

The combination of the negative Maksutov-like meniscus lens 6A and the Schmidt-like plate 7 facilitates the correction of chromatic aberration, because the contributions of these two elements to chromatic aberration are of opposite sign and tend to cancel.

It is anticipated that the optical system of this preferred embodiment may have application to surveillance, border control and military observation.

There is no implicit relationship between the scale of the Cassegrain-like front end of the system, and that of the rear end image relay/corrector system. The front-end merely provides an intermediate, aberrated image, on which the corrector operates. As the front end is scaled, the change in the degree of aberration requires that some parameters of the corrector should be optimized to compensate, but the format and overall dimensions of the corrector/relay need not be greatly changed.

The following examples employ correctors of similar layout and dimensions, while the Cassegrain-like front end is scaled by factors of two. Descriptions are given of variants with a 0.5 m pupil and a 4° field, a 1 m pupil and 2° field, a 2 m pupil and 1° field, a 4 m pupil and 0.5° field, and an 8 m pupil and 0.25° field, all having a final focal ratio of f/0.75 and an image diameter ˜26 mm. Scaling of the rear end image relay/corrector system itself, to match larger CCD imagers, would generally be constrained by the availability of some of the corrector glasses in suitably sized blanks.

The systems described in Examples 2 to 8 have an unusually high performance in the combination of throughput parameters, while maintaining a scalable pupil diameter in the range 0.5 m to >4 m, traded off only with field angle. They are three-mirror relayed catadioptrics, with spherical surfaces on all the mirrors and on all but one of the sub-diameter corrector lens surfaces. The image is made accessible from the rear of the system by the use of a small, flat fold mirror close to the image plane

Residual colour error in the systems is corrected by the multiple-component lens subsystem 6C which is fabricated from glasses selected according to the partial dispersion rules for super-achromats, resulting in a wide passband of 405-1000 nm. The remaining high-order aberrations are of sufficiently low amplitude that the dimensions of the residual blur are well matched to pixels measuring less than 10 μm over a usefully large flat focal surface at a N.A. of 0.667 (this is equal to a “speed” of f/0.75, but it should be noted that transmission losses in this type of system will generally reduce the effective speed—the “T-stop”—to a figure nearer to f/1).

The same format and size of the corrector module can be used in combination with separately scaled spherical primary/secondary mirrors. The pupil diameter can thus be chosen to match a specified task, while maintaining the same fast final focal ratio, image size and rms spot diameters to match a specific imaging device.

### EXAMPLE SYSTEM TWO

### Modified 0.5 m Pupil Diameter System

Table 2 lists the parameters of a further example system having a pupil diameter of 0.5 m, a speed of f/0.75, field angle of 4° , spectral passband of 430-1000 nm, image scale of 5.5 arcsec/10 μm, and image diameter of 26.37 mm.

The spherical primary mirror is approximately 40% oversize. This is to accommodate the marginal rays at the extreme field, because the entrance pupil, the real image of the aperture stop, is projected 2.3 m in front of the optic, in object space. The input numerical aperture of the corrector is 0.294 (f/1.7) and the output numerical aperture is 0.667 (f/0.75).

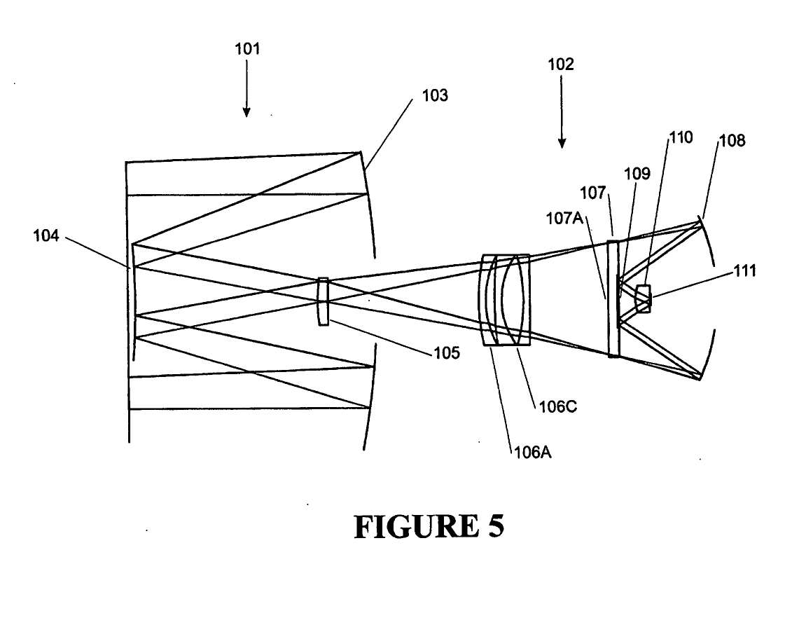

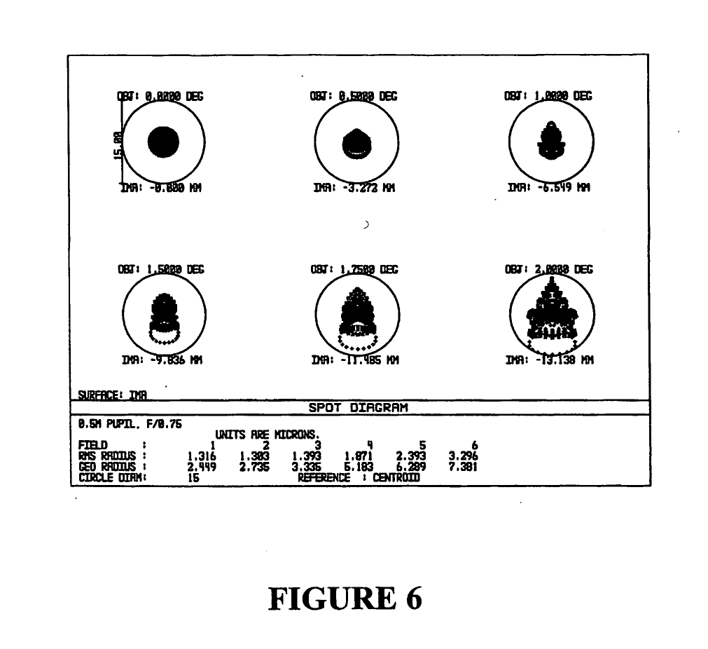

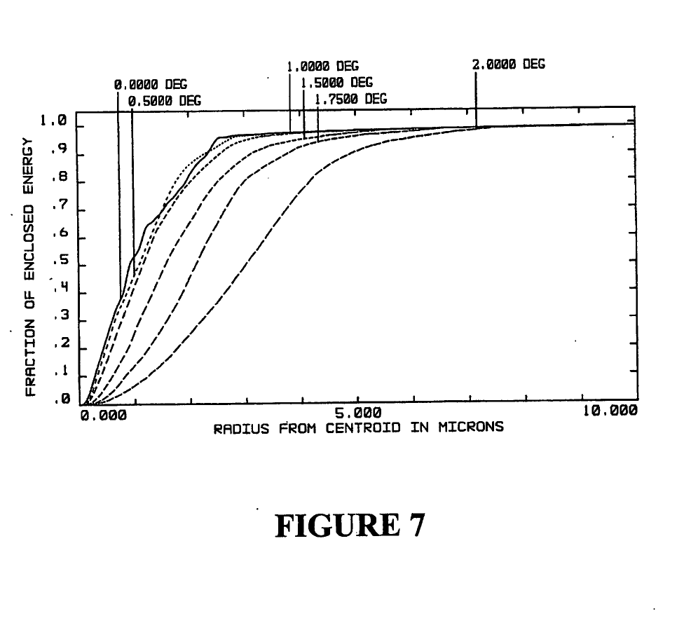

The layout of the system is shown in FIG. 5, in which like reference numerals are used to indicate like parts to the system of FIG. 1, each reference numeral being increased by the addition of 100. FIG. 6 shows the spot diagram of light distribution at the focal plane from point sources, for a passband of 430-1000 mm, over the 4° field angle. FIG. 7 illustrates the fraction of enclosed energy at various radii from the centroid of each spot.

The residual aberrations result in the rms spot diameter exceeding 5 μm only at the extreme outer annulus of the flat field. All three mirrors in the optical train are spherical, as are all but one of the surfaces of the sub-diameter corrector lenses. The focal region is accessible from the rear. The flat circular field contains about 10⁷ resolved image points and is thus well matched to multi-megapixel CCD imagers with ≦10 μm pixels.

TABLE 2
MODIFIED 0.5 m PUPIL DIAMETER SYSTEM

| | | Radius | | | Diameter |
|---|---|---|---|---|---|
| Surface | Comment | mm | Thickness mm | Glass | mm |
| 1 | Primary Mirror 103 | −1750.03 | −582.017 | MIRROR | 693 |
| 2 | Secondary Mirror 104 | −1580.64 | 439.169 | MIRROR | 272 |
| 3 | Field Lens 105 | 420.459 | 25 | N-BK7 | 110 |
| 4 | | −4889.87 | 365.427 | | 110 |
| 5 | Meniscus Corrector | 455.958 | 17.051 | N-SK16 | 210 |
| | 106A | | | | |
| 6 | | 215.148 | 21.355 | | 210 |
| 7 | Corrector 106C | 920.737 | 16.716 | N-K5 | 210 |
| 8 | (Cemented Triplet Lens) | 174.64 | 52.657 | N-KZFS4 | 210 |
| 9 | | −373.406 | 15.00 | N-F2 | 210 |
| 10 | | −15995.4 | 187.195 | | 210 |
| 11 | Aspheric Surface and | Infinity | 25 | N-BK7 | 260.17 |
| | Stop 107 | | | | |
| 12 | | Infinity | 234.642 | | 270 |
| 13 | Relay Mirror 108 | −448.769 | −234.642 | MIRROR | 383 |
| 14 | Folding Flat 109 | Infinity | 40 | MIRROR | 124 |
| 15 | Field Flattener 110 | 89.987 | 33.75 | N-BK7 | 63 |
| 16 | | Infinity | 1.875 | | 63 |
| 17 | Image 111 | Infinity | | | 26.29 |

Asphere on Surface 11
Coeff on r 2: 4.839e−005
Coeff on r 4: −3.460e−009
Coeff on r 6: 3.971e−014
Coeff on r 8: −2.484e−019

It was found necessary to set the lower limit of the spectral passband for this system to 430 nm, to reduce a chromatic coma flare in the outer field. The other examples of systems having a Cassegrain-like front end which follow have the shortest wavelength set to 405 nm.

The central obscuration is 28% of pupil area and the vignetting at the extreme field is 6.5%, caused by the parallax of the secondary and fold mirror central obscurations. Maximum distortion is 0.7%.

### EXAMPLE SYSTEM THREE

### Modified 0.5 m Pupil Diameter System with Window

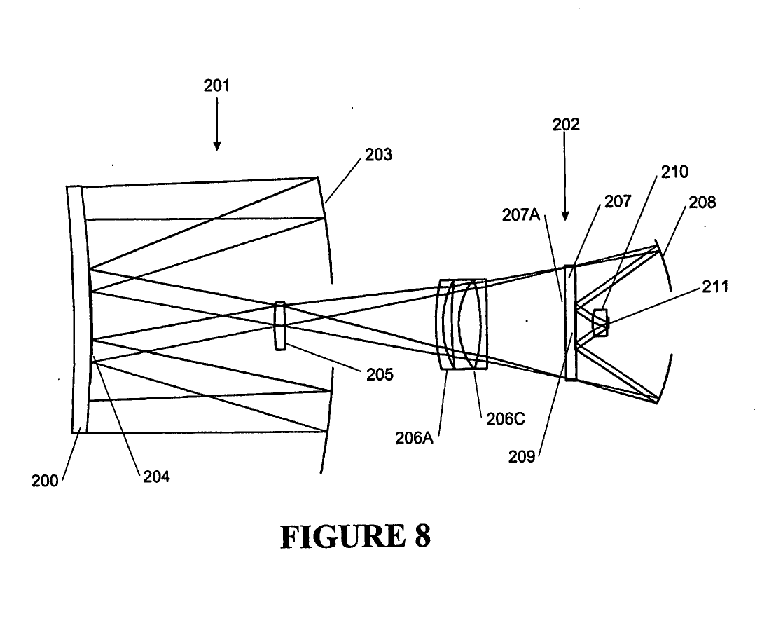

A modification of the second example system, having parameters listed in Table 3, enables mounting of the secondary mirror without the usual “spider” mount, thus removing the associated diffraction “spikes” from the image. The layout of the system is shown in FIG. 8, in which like reference numerals are used to indicate like parts to the system of FIG. 1, each reference numeral being increased by the addition of 200.

By inserting an optically very weak meniscus window 200 at the front of the system housing, the window being fabricated with a suitable second surface radius, a reflective silvered spot 204 on this surface can serve as the secondary mirror. In this design, the radius of the first surface of the meniscus window is made identical to that of the second surface, to enable simple testing if more than one is fabricated. The equal radii format is different from both Maksutov and Bouwers forms of meniscus correctors, and is used here entirely for convenience. The meniscus window 200, in combination with a housing, seals the optics from atmospheric detritus, and is also used here because the 0.5 m variant is the only one small enough for the window to be economically fabricated. It will be understood that rather than using a silvered spot on the second surface of the window, a secondary mirror could be mounted to the secondary surface of the window.

The corrector system adequately accommodates the relatively minor aberrations introduced by the meniscus-window, leading to the same image quality as that of the windowless version, so no performance data is given here. All other parameters are identical to those of the windowless version.

TABLE 3
MODIFIED 0.5 m PUPIL DIAMETER SYSTEM WITH WINDOW

| | | Radius | Thickness | | Diameter |
|---|---|---|---|---|---|
| Surface | Comment | mm | mm | Glass | mm |
| 1 | Meniscus Window 200 | −1580.489 | 30 | N-BK7 | 665 |
| 2 | | −1580.489 | 581.493 | | 665 |
| 3 | Primary Mirror 203 | −1756.43 | −581.493 | MIRROR | 700 |
| 4 | Secondary “Silvered Spot” 204 | −1580.489 | 447.148 | MIRROR | 275 |
| 5 | Field Lens 205 | 396.494 | 25 | N-BK7 | 110 |
| 6 | | 22360 | 363.079 | | 110 |
| 7 | Meniscus Corrector 206A | 449.103 | 26.207 | N-SK16 | 210 |
| 8 | | 213.595 | 21.461 | | 210 |
| 9 | Corrector 206C | 898.51 | 15.042 | N-K5 | 210 |
| 10 | (Cemented Triplet) | 173.803 | 52.997 | N-KZFS4 | 210 |
| 11 | | −370.393 | 15 | N-F2 | 210 |
| 12 | | −23122.54 | 187.074 | | 210 |
| 13 | Aspheric Surface and Stop | Infinity | 25 | N-BK7 | 260.6 |
| | 207A | | | | |
| 14 | | Infinity | 235.048 | | 272 |
| 15 | Relay Mirror 208 | −448.639 | −235.048 | MIRROR | 385 |
| 16 | Folding Flat 209 | Infinity | 40 | MIRROR | 123 |
| 17 | Field Flattener 210 | 89.586 | 33.75 | N-BK7 | 61.5 |
| 18 | | Infinity | 1.5 | | 61.5 |
| 19 | Image 211 | Infinity | | | 26.3 |

Asphere on Surface 13
Coeff on r 2: 4.6532e−005
Coeff on r 4: −3.3636e−009
Coeff on r 6: 4.0631e−014
Coeff on r 8: −2.2879e−019

### EXAMPLE SYSTEM 4

### 1 m Pupil Diameter System

Table 4 lists the parameters of a further example system having a pupil diameter of 1 m. This system has been designed in accordance with the abovementioned principle of maintaining the relay/corrector dimensions relatively constant while the Cassegrain-like front end is scaled, the 1 m system being designed to cover half the field angle covered by the 0.5 m pupil diameter system, ie 2° rather than 4°. Correspondingly, the primary mirror is oversize by only ˜25% in this design.

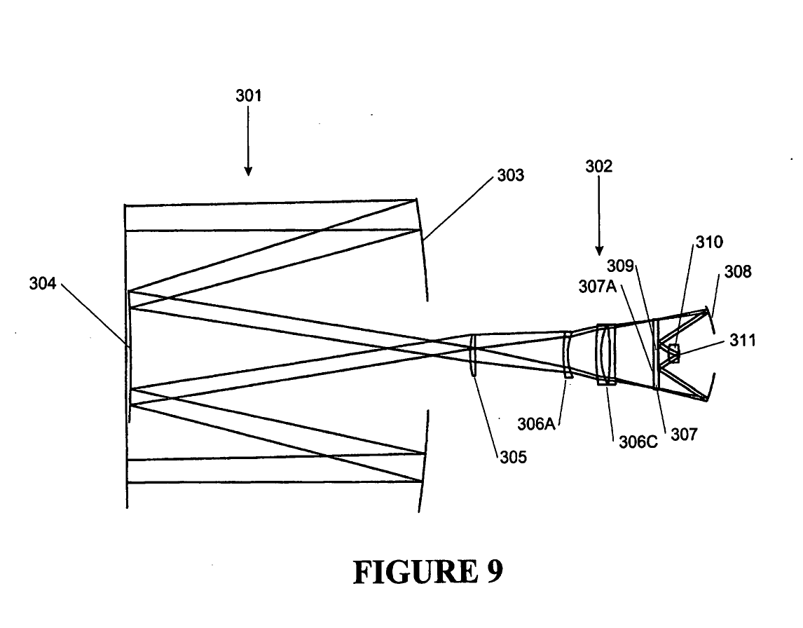

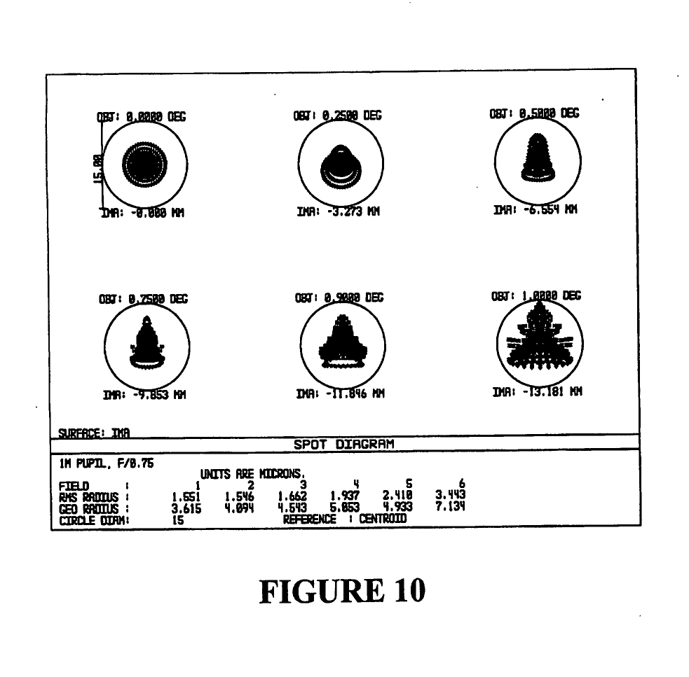

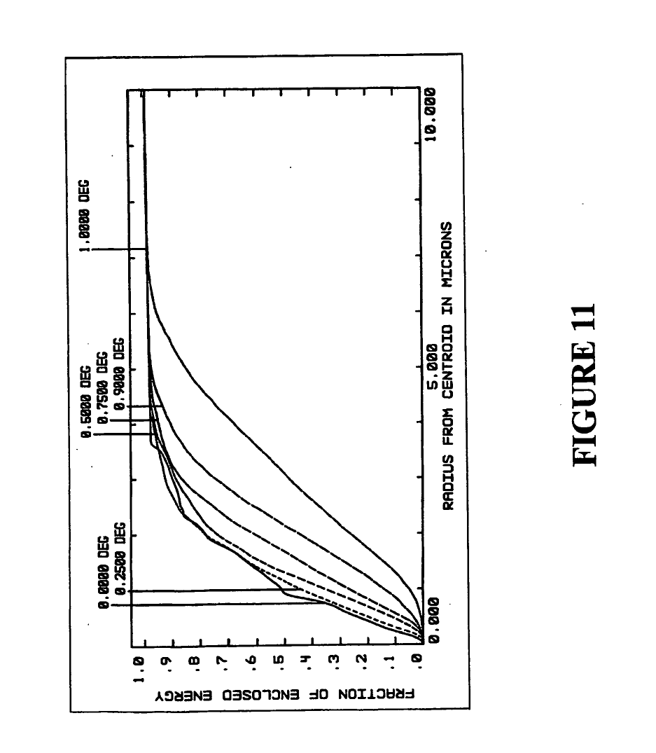

The layout of the system is shown in FIG. 9, in which like reference numerals are used to indicate like parts to the system of FIG. 1, each reference numeral being increased by the addition of 300. FIG. 10 shows the spot diagram of light distribution at the focal plane from point sources, for a passband of 405-1000 mm, over the 2° field angle (showing the aberration control). FIG. 11 illustrates the fraction of enclosed energy at various radii from the centroid of each spot.

In this example, the central obscuration is 27% of the pupil area and there is 3% vignetting at the outer field. The latter is due to the parallax of the secondary and fold mirrors' central obscurations. Maximum distortion is 1.4%.

TABLE 4
1 m PUPIL DIAMETER SYSTEM

| | | | Thickness | | Diameter |
|---|---|---|---|---|---|
| Surface | Comment | Radius mm | mm | Glass | mm |
| 1 | Primary Mirror 303 | −4016.58 | −1230.29 | MIRROR | 1254 |
| 2 | Secondary Mirror 304 | −4016.58 | 1398.87 | MIRROR | 528 |
| 3 | Field Lens 305 | 346.807 | 20 | N-BK7 | 163 |
| 4 | | 4562.834 | 362.71 | | 163 |
| 5 | Meniscus Corrector 306A | 540.658 | 18.401 | N-SK16 | 185 |
| 6 | | 227.232 | 115.082 | | 185 |
| 7 | Corrector 306C | 958.73 | 20 | N-K5 | 240 |
| 8 | (Cemented Triplet) | 287.264 | 35.848 | N-KZFS4 | 240 |
| 9 | | −953.2 | 20 | N-F2 | 240 |
| 10 | | 2706.314 | 157.80 | | 240 |
| 11 | Aspheric Surface and | Infinity | 20 | N-BK7 | 271.1 |
| | Stop 307A | | | | |
| 12 | | Infinity | 235 | | 278 |
| 13 | Relay Mirror 308 | −476.432 | −235 | MIRROR | 378 |
| 14 | Folding Flat 309 | Infinity | 40 | MIRROR | 130 |
| 15 | Field Flattener 310 | 87.63 | 42.526 | N-BK7 | 69.5 |
| 16 | | Infinity | 1.5 | | 69.5 |
| 17 | Image 311 | Infinity | | | 26.37 |

Asphere on surface 11
Coeff on r 2: 5.5575e−005
Coeff on r 4: −3.3386e−009
Coeff on r 6: 1.9281e−014
Coeff on r 8: −1.1825e−019

In this example the primary and secondary mirrors have identical radii. This ratio has no particular optical significance, but was chosen to simplify fabrication of the spherical secondary mirror, by making it testable against the primary mirror. The corrector's input N.A. is 0.243 (f/2) and the output N.A. is 0.667 (f/0.75). The reduction of the input N.A. from that of the 0.5 m system was a consequence of the optimization process, in which the increased spherical aberration of the larger pupil was balanced against the decreased coma of the lower field angle. This effect continues with the larger pupil sizes described below.

### EXAMPLE SYSTEM FIVE

### 1 m Pupil System with Radii Matched to Standard Tools

Table 5 provides the prescription for a modified 1 m pupil diameter system, in which all the powered refractive surfaces have their radii chosen from the restricted list of tool radii available in a standard optical workshop. The performance of the adjusted system is virtually identical to that of the fully optimized system of Table 4, so is not shown here. This illustrates the adaptability of the design, in that the remaining degrees of freedom provided by the mirror radii, glass thicknesses and air spaces, are sufficient to achieve adequate predicted performance after re-optimization within this constraint.

TABLE 5
1 M PUPIL DIAMETER SYSTEM FABRICATED USING STANDARD
TOOLS

| | | | Thickness | | |
|---|---|---|---|---|---|
| Surface | Comment | Radius mm | mm | Glass | Diameter mm |
| 1 | Primary Mirror 303 | −4012.69 | −1199.3 | MIRROR | 1254 |
| 2 | Secondary Mirror 304 | −4012.69 | 1475.44 | MIRROR | 546 |
| 3 | Field Lens 305 | 349.9 | 20 | N-BK7 | 165 |
| 4 | | 3550 | 366.97 | | 165 |
| 5 | Meniscus Corrector | 554.3 | 37.252 | N-SK16 | 185 |
| | 306A | | | | |
| 6 | | 226.9 | 122.231 | | 185 |
| 7 | Corrector 306C | 918 | 16 | N-K5 | 240 |
| 8 | (Cemented Triplet) | 289.2 | 35 | N-KZFS4 | 240 |
| 9 | | −918 | 15 | N-F2 | 240 |
| 10 | | 2527 | 167.956 | | 240 |
| 11 | Aspheric Surface and | Infinity | 20 | N-BK7 | 275.5 |
| | Stop 307A | | | | |
| 12 | | Infinity | 237.868 | | 285 |
| 13 | Relay Mirror 308 | −479.042 | −237.868 | MIRROR | 385 |
| 14 | Folding Flat 309 | Infinity | 40 | MIRROR | 128 |
| 15 | Field Flattener 310 | 87.63 | 40 | N-BK7 | 68 |
| 16 | | Infinity | 1.5 | | 68 |
| 17 | Image 311 | Infinity | | | 26.37 |

Asphere on surface 11
Coeff on r 2: 5.8229e−005
Coeff on r 4: −3.3576e−009
Coeff on r 6: 1.7288e−014
Coeff on r 8: −1.0736e−019

### EXAMPLE SYSTEM SIX

### 2 m Pupil Diameter System

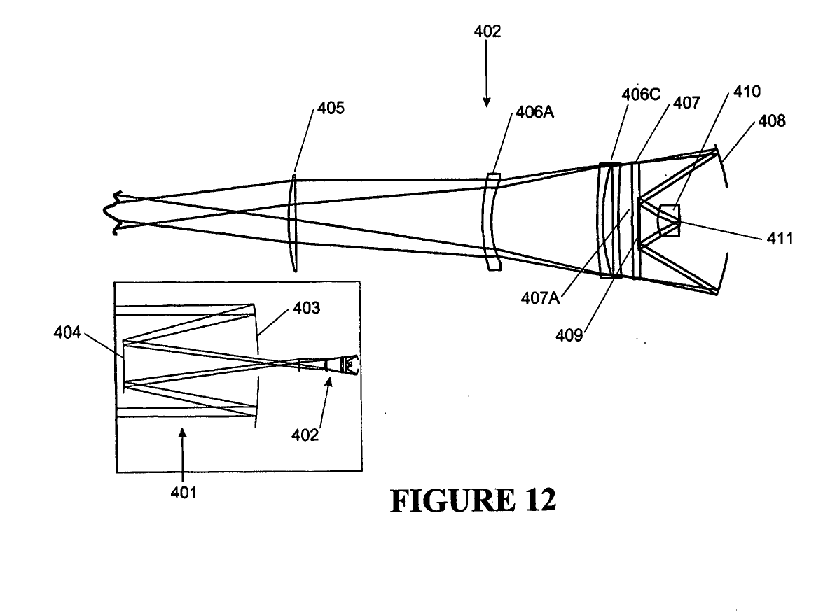

Using the scaling procedure discussed above, a 2 m pupil was created by doubling the dimensions of the 1 m pupil primary/secondary pair, and halving the field angle to 1°. This was followed by some manipulation of conjugates and a re-optimization. The resulting corrector layout is seen in FIG. 12, in which like reference numerals are used to indicate like parts to the system of FIG. 1, each reference numeral being increased by the addition of 400. It will be noted that the main part of FIG. 12 shows the enlarged details of the corrector/rear end relay, while the inset shows the imaging system overall.

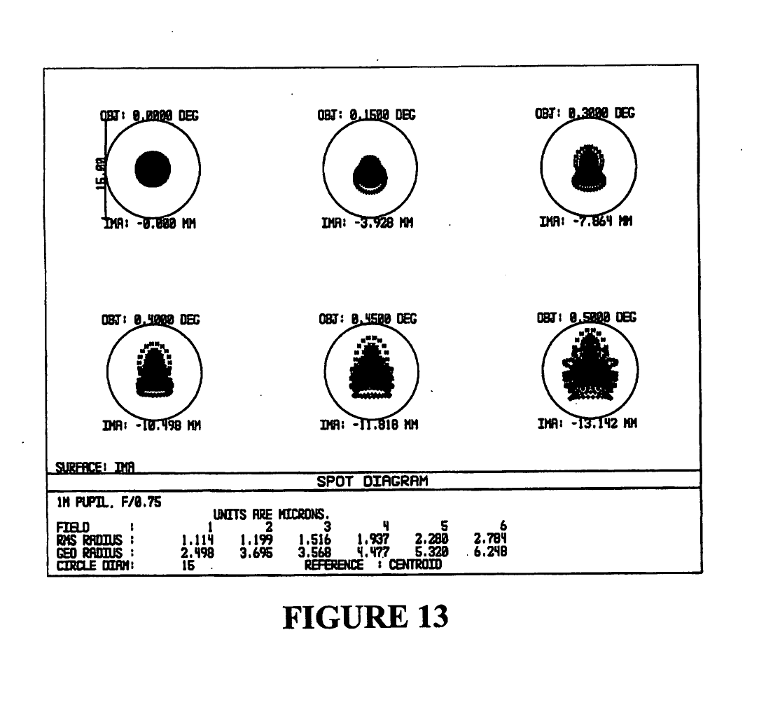

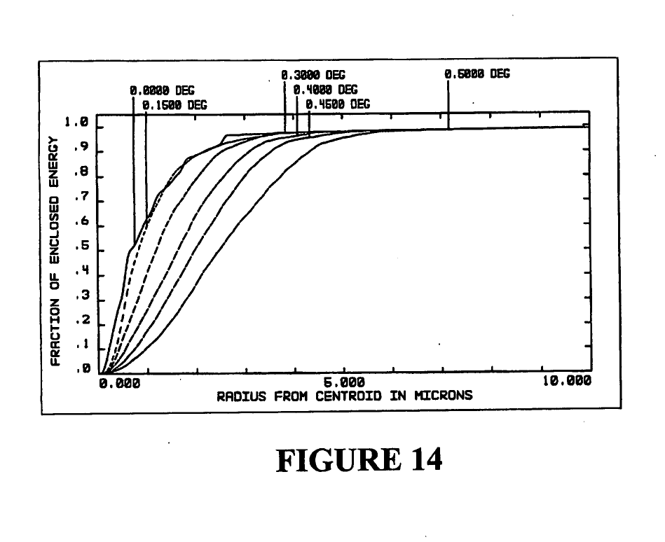

The prescription for this system is listed in Table 6. FIG. 13 shows the spot diagram of light distribution at the focal plane from point sources, for a passband of 405-1000 nm, over the 1° field angle, this Figure indicating the aberration control. FIG. 14 illustrates the fraction of enclosed energy at various radii from the centroid of each spot.

It can be seen that the image quality is very similar to that of the 1 m pupil diameter system. The corrector's input N.A. is 0.214 (f/2.3) and the output N.A. is 0.667 (f/0.75). The central obstruction is 26% and vignetting at the extreme field is 6%. Maximum distortion is 0.8%.

TABLE 6
2 M PUPIL DIAMETER SYSTEM

| | | | Thickness | | Diameter |
|---|---|---|---|---|---|
| Surface | Comment | Radius mm | mm | Glass | mm |
| 1 | Primary Mirror 403 | −9279.405 | −2740 | MIRROR | 2422 |
| 2 | Secondary Mirror 404 | −9279.405 | 3563.818 | MIRROR | 1039 |
| 3 | Field Lens 405 | 544.775 | 20 | N-BK7 | 240 |
| 4 | | −49158.71 | 521.677 | | 240 |
| 5 | Meniscus Corrector 406A | 477.391 | 25 | N-SK16 | 240 |
| 6 | | 271.102 | 293.192 | | 240 |
| 7 | Corrector 406C | 1311.293 | 15 | N-K5 | 310 |
| 8 | (Cemented Triplet) | 485.245 | 28.27 | N-KZFS4 | 310 |
| 9 | | −14163.27 | 15 | N-F2 | 310 |
| 10 | | 1707.348 | 37.772 | | 310 |
| 11 | Aspheric Surface and Stop | Infinity | 20 | N-BK7 | 309 |
| | 407A | | | | |
| 12 | | Infinity | 248.566 | | 316 |
| 13 | Relay Mirror 408 | −555.163 | −248.566 | MIRROR | 405 |
| 14 | Folding Flat 409 | Infinity | 50 | MIRROR | 154 |
| 15 | Field Flattener 410 | 99.27 | 58.496 | N-BK7 | 84 |
| 16 | | Infinity | 1.5 | | 84 |
| 17 | Image 411 | Infinity | | | 26.29 |

Asphere on Surface 11
Coeff on r 2: 4.1357e−005
Coeff on r 4: −1.9085e−009
Coeff on r 6: 8.226e−015
Coeff on r 8: −2.4726e−020

### EXAMPLE SYSTEM SEVEN

### 4 m Pupil Diameter System

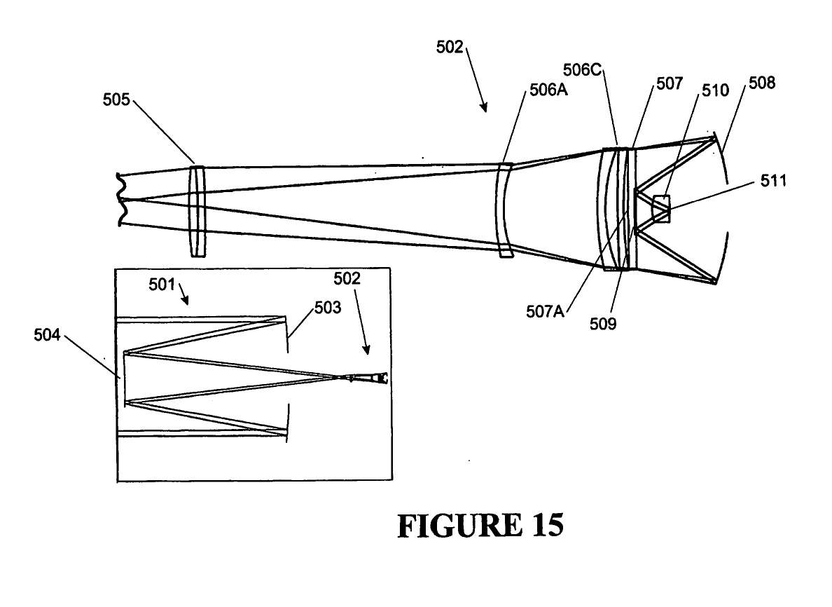

The scaling process was continued to achieve a 4 m pupil diameter with half the field angle of the 2 m design. FIG. 15 illustrates the layout of the corrector module and system overall, in which like reference numerals are used to indicate like parts to the system of FIG. 1, each reference numeral being increased by the addition of 500.

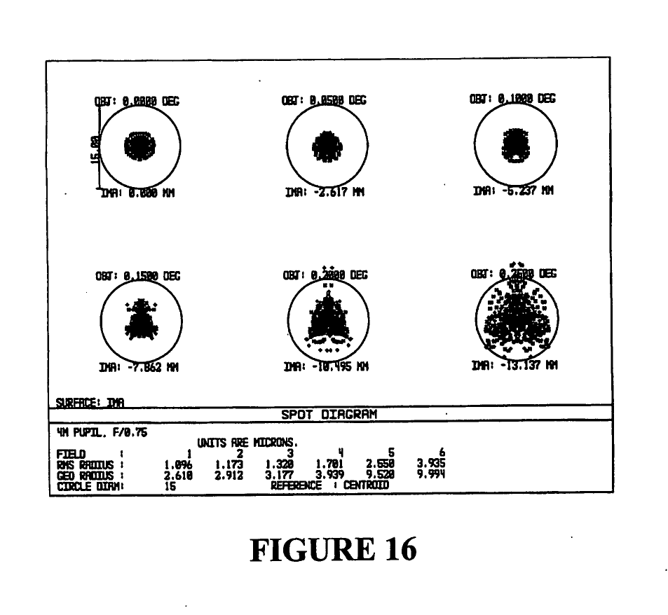

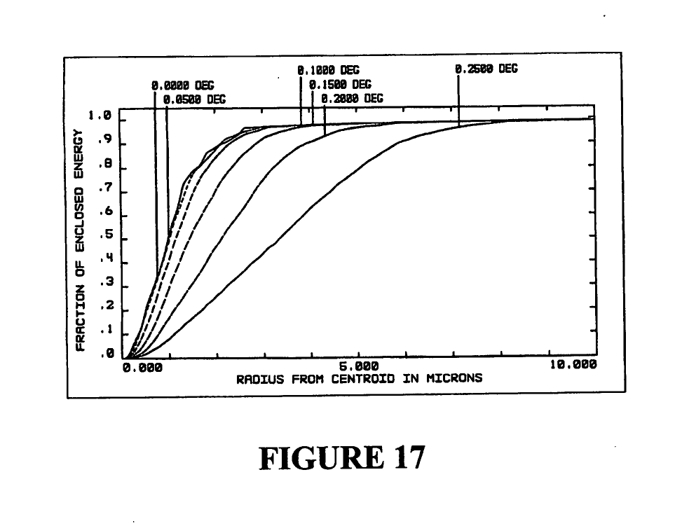

The prescription for this system is listed in Table 7. FIG. 16 shows the spot diagram of light distribution at the focal plane from point sources, for a passband of 405-1000 nm, over the 0.5° field angle (showing the aberration control). FIG. 17 illustrates the fraction of enclosed energy at various radii from the centroid of each spot.

The correction is seen to be of generally similar quality, but with a significant degradation at the extreme field. In addition, in this embodiment the field/transfer lens 505 has been changed from a singlet to a doublet form, to reduce the lateral color that was evident in the outer field when a singlet was used.

The corrector's input N.A. is 0.189 (f/2.6) and the output N.A. is 0.667 (f/0.75). The central obscuration is 25.5% and vignetting 0.5% for the 0.5° field of this design. Distortion is a maximum of 0.76%.

TABLE 7
4 M PUPIL DIAMETER SYSTEM

| | | | Thickness | | Diameter |
|---|---|---|---|---|---|
| Surface | Comment | Radius mm | mm | Glass | mm |
| 1 | Primary Mirror 503 | −21017.2 | −5980 | MIRROR | 4565 |
| 2 | Secondary Mirror 504 | −21017.2 | 8290.499 | MIRROR | 2018 |
| 3 | Transfer Doublet 505 | 933.532 | 22 | N-SK16 | 245 |
| 4 | | −1548.5 | 18 | N-F2 | 245 |
| 5 | | −3057.34 | 739.3662 | | 245 |
| 6 | Meniscus Corrector 506A | 598.053 | 21.08227 | N-SK16 | 235 |
| 7 | | 291.463 | 236.3992 | | 235 |
| 8 | Corrector 506C | 697.679 | 20 | N-K5 | 300 |
| 9 | (Cemented Triplet) | 393.546 | 30.54729 | N-KZFS4 | 300 |
| 10 | | 3561.484 | 15 | N-F2 | 300 |
| 11 | | 992.378 | 10.7634 | | 300 |
| 12 | Aspheric Surface and Stop | Infinity | 20 | N-BK7 | 291 |
| | 507A | | | | |
| 13 | | Infinity | 232.907 | | 300 |
| 14 | Relay Mirror 508 | −506.254 | −232.907 | MIRROR | 378 |
| 15 | Folding Flat 509 | Infinity | 40 | MIRROR | 129 |
| 16 | Field Flattener 510 | 90.195 | 43.21561 | N-BK7 | 70 |
| 17 | | Infinity | 1.5 | | 70 |
| 18 | Image 511 | Infinity | | | 26.27 |

Asphere on Surface 12
Coeff on r 2: 6.6456e−005
Coeff on r 4: −3.3063e−009
Coeff on r 6: 9.7451e−015
Coeff on r 8: −6.3243e−020

### EXAMPLE SYSTEM EIGHT

### 8 m Pupil Diameter System

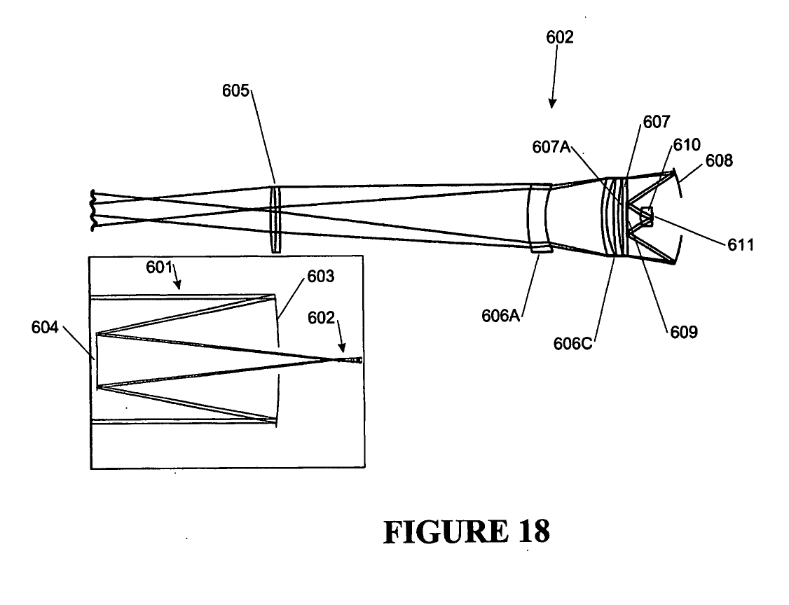

An 8 m pupil diameter was created, to test of the limits of the scaling process. FIG. 18 illustrates the layout of the relay/corrector module and system overall, in which like reference numerals are used to indicate like parts to the system of FIG. 1, each reference numeral being increased by the addition of 600.

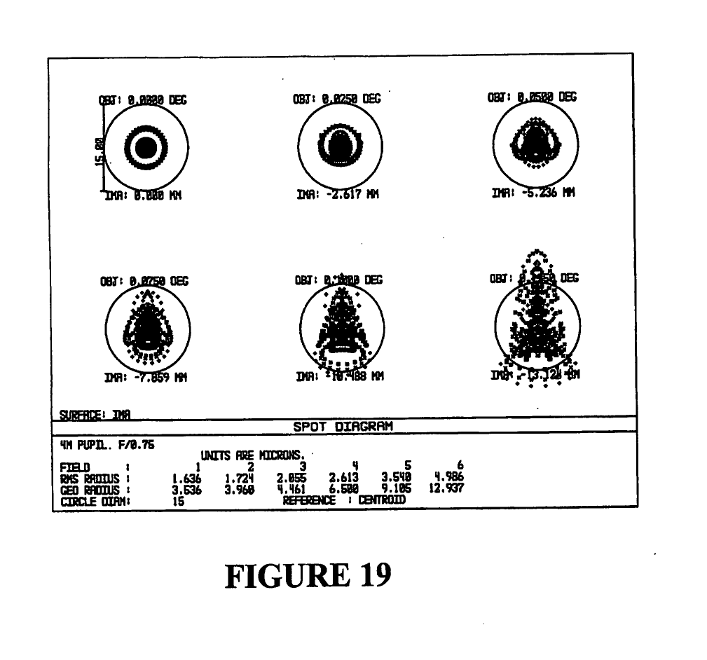

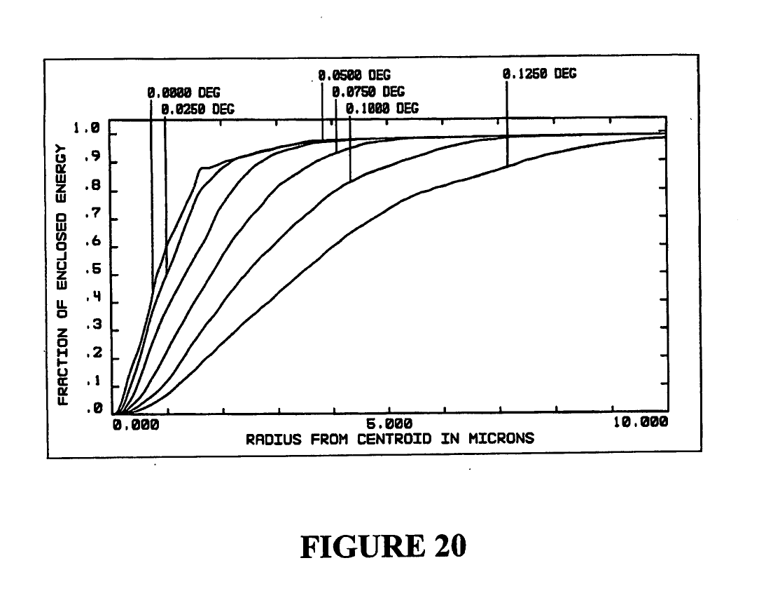

The prescription for this system is listed in Table 8. FIG. 19 shows the spot diagram of light distribution at the focal plane from point sources, for a passband of 405-1000 nm, over the 0.25° field angle (showing the aberration control). FIG. 20 illustrates the fraction of enclosed energy at various radii from the centroid of each spot.

It is evident that there is a general degradation relative to the 4 m system performance, also a further reduction in the useable linear field diameter at the final image, based on the attainable resolution in the smaller scale systems. Moreover, the input N.A. to the corrector has had to be reduced to 0.167, rendering the spherical front end module 14 m in length and the overall system 20 m. The reduction in spherical aberration, concomitant with the reduction in N.A, nevertheless allows the least circle of confusion at the intermediate focus to be 7% of the field radius. That this is reduced to 0.054% at four times the N.A. at the final focus is a measure of the correction achieved, even in this overstressed scaled-up variant.

TABLE 8
8 M PUPIL DIAMETER SYSTEM

| | | | | | Diameter |
|---|---|---|---|---|---|
| Surface | Comment | Radius mm | Thickness mm | Glass | mm |
| 1 | Primary Mirror 603 | −47788.7 | −13626.75 | MIRROR | 9004 |
| 2 | Secondary Mirror 604 | −47788.7 | 18381.18 | MIRROR | 3926 |
| 3 | Transfer Doublet 605 | 1171.928 | 22 | N-SK16 | 280 |
| 4 | | −2144.065 | 18 | N-F2 | 280 |
| 5 | | −9028.784 | 1055.033 | | 280 |
| 6 | Meniscus Corrector | 577.3 | 75 | N-SK16 | 290 |
| | 606A | | | | |
| 7 | | 329.990 | 236.515 | | 266 |
| 8 | Corrector 606C | 570.022 | 20 | N-K5 | 330 |
| 9 | (Cemented Triplet) | 381.658 | 30.717 | N-KZFS4 | 330 |
| 10 | | 1266.635 | 20 | N-F2 | 330 |
| 11 | | 714.238 | 18.037 | | 319 |
| 12 | Aspheric Surface and | Infinity | 20 | N-BK7 | 319 |
| | Stop 607A | | | | |
| 13 | | Infinity | 232.918 | | 330 |
| 14 | Relay Mirror 608 | −550.008 | −232.918 | MIRROR | 400 |
| 15 | Folding Flat 609 | Infinity | 55 | MIRROR | 151.6 |
| 16 | Field Flattener 610 | 97.732 | 48.576 | N-BK7 | 74.4 |
| 17 | | Infinity | 1.5 | | 74.4 |
| 18 | Image 611 | Infinity | | | 26.24 |

Asphere on Surface 12
Coeff on r 2: 6.9895e−005
Coeff on r 4: −2.8747e−009
Coeff on r 6: 6.1453e−015
Coeff on r 8: −4.4875e−020

The starting point for the above systems was the commercial requirement for a very fast, high resolution system having a pupil diameter of approximately 0.5 m, with a 400-1000 nm passband and a usefully large field angle.

The glasses for the triplet chosen here are especially interesting, in that the combination of N-K5, N-KzFS4, and N-F2 can be fabricated as a cemented triplet. The expansion coefficients have differentials of only ˜1.10⁻⁶, even over an extended temperature range, the worst being 1.4.10⁻⁶ between N-K5 and N-KzFS4 over the 20-300° C. range, dropping to 0.9.10⁻⁶ for the range 30-70° C.

It is evident, from a perusal of the layout diagrams of the correctors, that the optimization process has adjusted several parameters of the system between scaling steps. These include the N.A. of the Cassegrain-like intermediate imaging unit, the position of the field/transfer lens relative to the intermediate image, and the positions of the meniscus and triplet corrector elements relative to the aperture stop. One penalty arising from this process is the increasing extension of the entrance pupil—the real image of the aperture stop—projected into object space in front of the systems. This leads to a significant degree of oversize of the primary mirror, in particular, so as to accommodate the marginal rays at the extreme field. Of the designs listed here, the worst is the 4°-field, 0.5 m system at 38% oversize, with the others progressively improving on this value, down to 13% for the 8 m system. However, the associated extra cost is at least partly compensated by the lower cost of fabrication of the spherical surfaces.

The single aspheric surface at the aperture stop preferably has the same height at both axial and marginal radii, to facilitate fabrication. The maximum sag of this surface increased from 185 μm to 435 μm as the pupil diameter was increased between systems, but was not monotonic, as the sag for the 2 m system was 30% less than expected. Moreover, the balance of aberration correction, between spherical, coma, astigmatism and color, appears to be optimized best in the 2 m pupil diameter system, the residual blur at all field positions having less than 10 μm encircled energy diameter. A particularly desirable result of the 2 m pupil diameter system is the general compactness of the residual high-order aberration spot, with no boundary instability evident. This is reflected in the correction evident in the other examples, over most of the field.

The catadioptric relay/focal-reducer module successfully corrects the aberrations of a spherical-mirror Cassegrain-like catoptric imaging unit, such that a spectral passband of 405-1000 nm can be achieved at a speed of f/0.75 (N.A.=0.667) over a flat focal plane 26 mm diameter with a residual blur <6 μm rms diameter. The relay contains only one aspheric surface, all others being spherical.

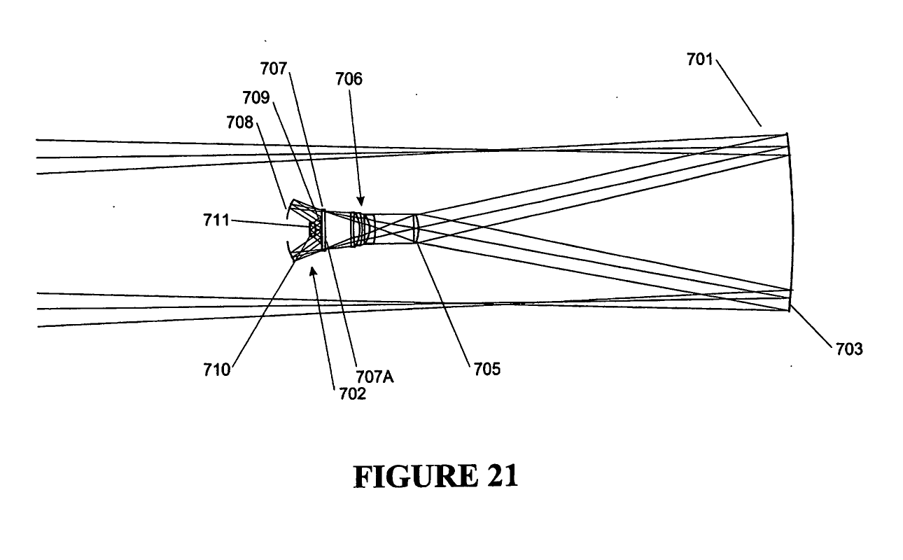

FIG. 21 shows an optical imaging system in accordance with an alternative embodiment of the present invention, in which like numerals reference like parts to FIG. 1, each reference numeral being increased by the addition of 700. The main difference between this optical system and the optical systems outlined above is that the front end imaging system has only a primary concave mirror, whereas the front end imaging system of FIG. 1 has a Cassegrain-like front end.

The alternative imaging system includes a front end 701 and a rear end 702. In this embodiment, the front end 701 has only a primary concave mirror 703, rather than a Cassegrain-like front end. The front end 701 could have one or more mirrors of any suitable configuration, provided it can provide an intermediate image.

A field lens system 705 is located near the image of the front end 701 and has a function to image the aperture stop of the rear end image relay system to a position where it forms the entrance pupil of the optical imaging system.

Following the field lens is a corrector group 706. The corrector group 706 again preferably includes a Maksutov-like meniscus lens, a filter and a doublet lens as does the system of FIG. 1. While a doublet lens is used in the preferred embodiment, a triplet lens or other multiple-lens subsystem may be used. The doublet lens is constructed using glass of particular relative partial dispersions in both the infra-red and violet portions of the spectrum, thereby allowing the system to be used over a wide visible and near infra-red waveband. Such a construction assists in the correction of chromatic aberration, introduced to the image due to the refractive elements of the imaging system.

While the corrector group 706 of this embodiment has the same components as the corrector group 6 of the system of FIG. 1, their parameters are selected to match the aberrations generated by the concave primary mirror 703. Accordingly, the values of radii and thickness for the components of the corrector group 706 are dependent on the front end 701, and would therefore differ from those of the corrector group 6.

Again the system includes an aberration correcting element, such as a lens 707, which is preferably a Schmidt-like plate. The location and details of the lens 707 are substantially as described with reference to FIG. 1. However, the coefficients of the asphere will depend on the front end 701, and will therefore differ from those of the lens 7 of the system of FIG. 1.

Again, other correcting elements may be implemented in various forms other than through a lens located substantially at the aperture stop of the imaging system. These may include alternative and/or additional refractive or reflective components located at various positions.

The rear end 702 is a high speed relay system having a concave relay mirror 708 and a folding flat mirror 709. After the rear end 702 receives an image at the field lens system 705, this image is re-imaged by the relay mirror 708 and folding flat mirror 709 to form an image on a detector 711. A field flattener 710 may be provided in the optical path immediately preceding the detector 711 in order to adapt the image to be suitable for detection by a planar imaging device.

Again, a key feature of the alternative optical system is its ability to be designed so that aberrations introduced by the front end 701 are at least partly cancelled by introducing equal and opposite aberrations in the rear end 702 and vice versa In particular, the meniscus/plate combination provides simultaneous control of spherical aberration without introducing significant spherochromatic aberration, allowing the imaging system to maintain good image definition across a wide range of wavelengths.

### EXAMPLE SYSTEM NINE

### Non-Cassegrain-like Front End with Tilted Fold Mirror

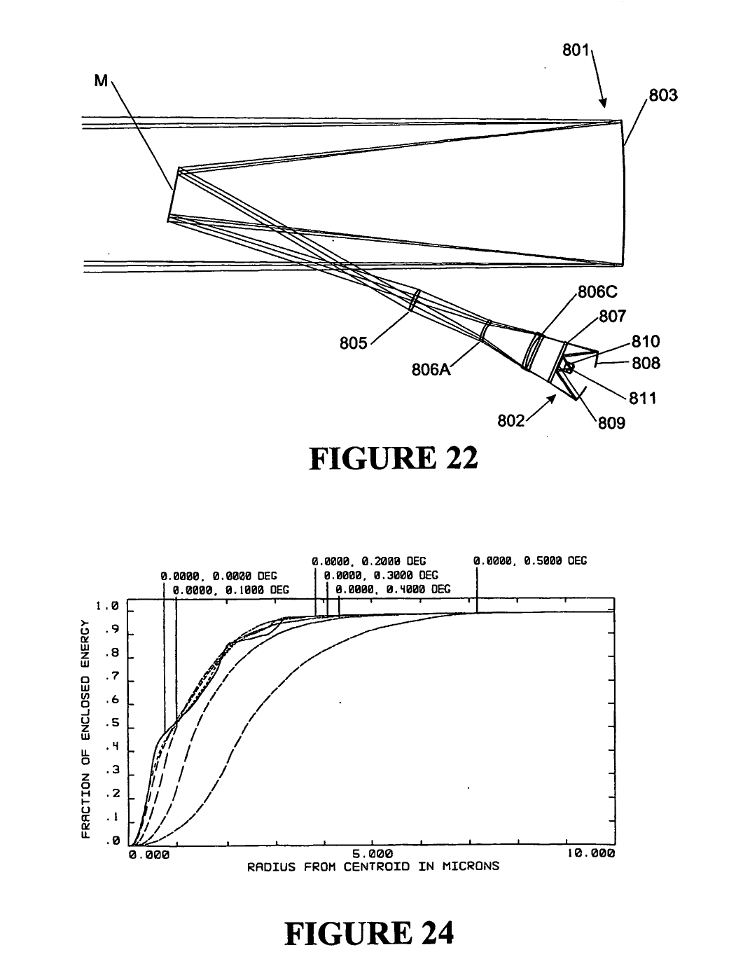

FIG. 22 shows an optical imaging system in accordance with an alternative embodiment of the present invention in which like numerals reference like parts to FIG. 1, each reference numeral being increased by the addition of 800. Again, this optical system differs from the optical system of FIG. 1 in that the front end imaging system 801, is non-Cassegrain-like. The front end imaging system 801 has a concave primary mirror 803. Light is reflected from the primary mirror 803 to a mirror M which is oriented on an angle to deflect the focus. In this embodiment, the mirror M deflects the entire relay 802 to one side. The mirror M may be oriented so that the rear end is deflected by an angle between 0° and possibly up to greater than 90°. In the embodiment shown the mirror is tilted at an angle of 12°.

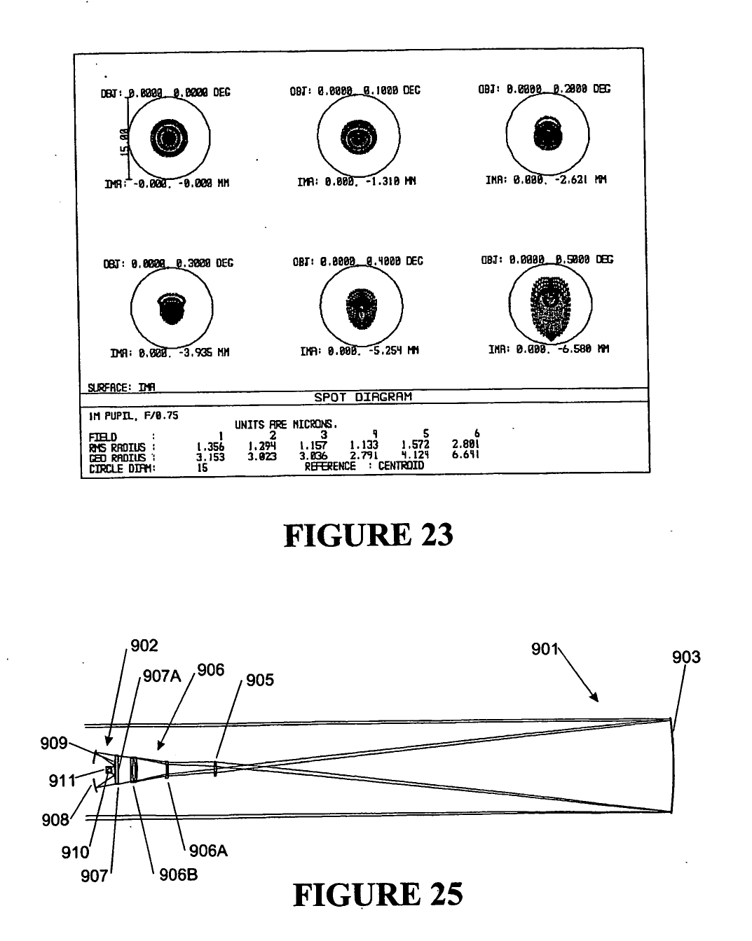

The prescription for this system is listed in Table 9. FIG. 23 shows the spot diagram of light distribution at the focal plane from point sources, for a passband of 405-1000 nm. FIG. 24 illustrates the fraction of enclosed energy at various radii from the centroid of each spot.

TABLE 9
NON-CASSEGRAIN-LIKE FRONT END WITH TILTED MIRROR

| | | | Thickness | | Diameter |
|---|---|---|---|---|---|
| Surface | Comment | Radius mm | mm | Glass | mm |
| 1 | Primary Mirror 803 | −9462.644 | −3196 | MIRROR | 1032 |
| 2 | Secondary Mirror M | Infinity | 1844 | MIRROR | 406 |
| 3 | Transfer Lens 805 | 363.58 | 20 | N-BK7 | 162 |
| 4 | | 6136.408 | 523.628 | | 162 |
| 5 | Meniscus Corrector 806A | 464.966 | 13.54 | N-SK16 | 166 |
| 6 | | 209.35 | 337.386 | | 166 |
| 7 | Colour Corrector 806C | 1260.296 | 15 | N-K5 | 280 |
| 8 | (CEMENTED TRIPLET) | 411.303 | 28.995 | N-KZFS4 | 280 |
| 9 | | −4025.99 | 15 | N-F2 | 280 |
| 10 | | 1667.905 | 160.78 | | 280 |
| 11 | Aspheric Surface and Stop | Infinity | 20 | N-BK7 | 308.94 |
| | 807A | | | | |
| 12 | | Infinity | 251.651 | | 314 |
| 13 | Relay Mirror 808 | −556.194 | −251.651 | MIRROR | 400 |
| 14 | Folding Flat 809 | Infinity | 50 | MIRROR | 132.6 |
| 15 | Field Flattener 810 | 90.115 | 52.847 | N-BK7 | 66 |
| 16 | | Infinity | 1.5 | | 66 |
| 17 | Image 811 | Infinity | | | 13.17 |

Asphere on Surface 11
Coeff on r 2: 3.9311e−005
Coeff on r 4: −1.6869e−009
Coeff on r 6: 2.0441e−015
Coeff on r 8: −2.2655e−020

While the tilted mirror is present as part of the front end 801, it will be understood that the tilted mirror could be positioned elsewhere in the system to deflect the focus. For example, the tilted mirror M could be present in the rear end 802 to change the orientation of part of the relay.

As outlined above, the preferred embodiments may use spherical mirrors in their front ends. However, the use of spherical mirrors, while being the preferred embodiment due to reduced fabrication costs, is not essential to the functioning of the invention. The systems could include other types of primary mirrors, such as the paraboloid primary mirror of a Newtonian system (as outlined below in Example System 10), or primary/secondary mirror pairs such as a true Cassegrain system of a paraboloid primary and hyperboloid secondary or a Dall-Kirkham-type ellipsoid primary and spherical secondary.

### EXAMPLE SYSTEM TEN

### Front End with Paraboloid Primary Mirror

FIG. 25 shows an optical system in accordance with an alternative embodiment of the present invention in which like reference numerals indicate like parts to FIG. 1, each reference numeral being increased by the addition of 900. Again, this system differs from the optical system of FIG. 1 in that the front end imaging system 901 is non-Cassegrain-like. The front end imaging system consists of a paraboloid primary mirror 903.

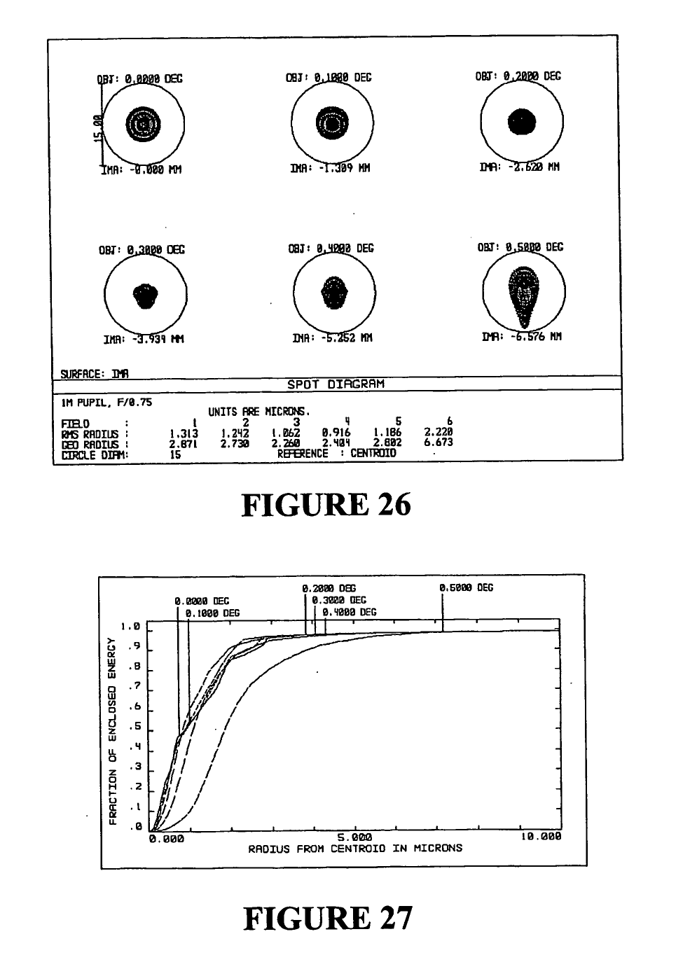

The prescription for this system is listed in Table 10. FIG. 26 shows the spot diagram of light distribution at the focal plane from point sources, for a passband of 405-1000 nm. FIG. 27 illustrates the fraction of enclosed energy at various radii from the centroid of each spot.

TABLE 10
NON-CASSEGRAIN-LIKE FRONT END WITH PARABOLOID
PRIMARY MIRROR

| | | Radius, | Thickness, | | Diameter, | Conic |
|---|---|---|---|---|---|---|
| Surface | Comment | mm. | mm. | Glass | mm. | constant |
| 1 | Paraboloid Primary | −9441.676 | −5040.000 | MIRROR | 1051.439 | 1.000 |
| | Mirror 903 | | | | | |
| 2 | Transfer Lens 905 | −364.960 | −20.000 | N-BK7 | 161.444 | |
| 3 | | −4027.610 | −511.395 | | 161.329 | |
| 4 | Meniscus Corrector | −471.595 | −10.000 | N-SK16 | 165.418 | |
| | 906A | | | | | |
| 5 | | −211.951 | −334.625 | | 163.016 | |
| 6 | Colour Corrector | −1299.387 | −15.000 | N-K5 | 280.000 | |
| | 906C | | | | | |
| 7 | (Cemented Triplet) | −400.124 | −29.876 | N-KZFS4 | 280.000 | |
| 8 | | 3793.721 | −15.000 | N-F2 | 280.000 | |
| 9 | | −1651.392 | −158.678 | | 272.723 | |
| 10 | Aspheric Surface | Infinity | −20.000 | N-BK7 | 309.795 | |
| | and Stop 907A | | | | | |
| 11 | | Infinity | −252.688 | | 314.601 | |
| 12 | Relay Mirror 908 | 554.987 | 252.688 | MIRROR | 393.776 | |
| 13 | Folding Flat 909 | Infinity | −50.000 | MIRROR | 131.437 | |
| 14 | Field Flattener 910 | −89.589 | −51.278 | N-BK7 | 63.770 | |
| 15 | | Infinity | −1.500 | | 16.144 | |
| 16 | Image 911 | Infinity | | | 13.163 | |

Asphere on Surface 10
Coeff on r 2: −4.1478e−005
Coeff on r 4: 1.7863e−009
Coeff on r 6: −2.5701e−015
Coeff on r 8: 2.4134e−020

The paraboloid primary mirror has no spherical aberration on-axis, but a large amount of off-axis spherical aberration (coma). The corrector elements have been optimized to address this error by removing the coma up to a limiting off-axis angle.

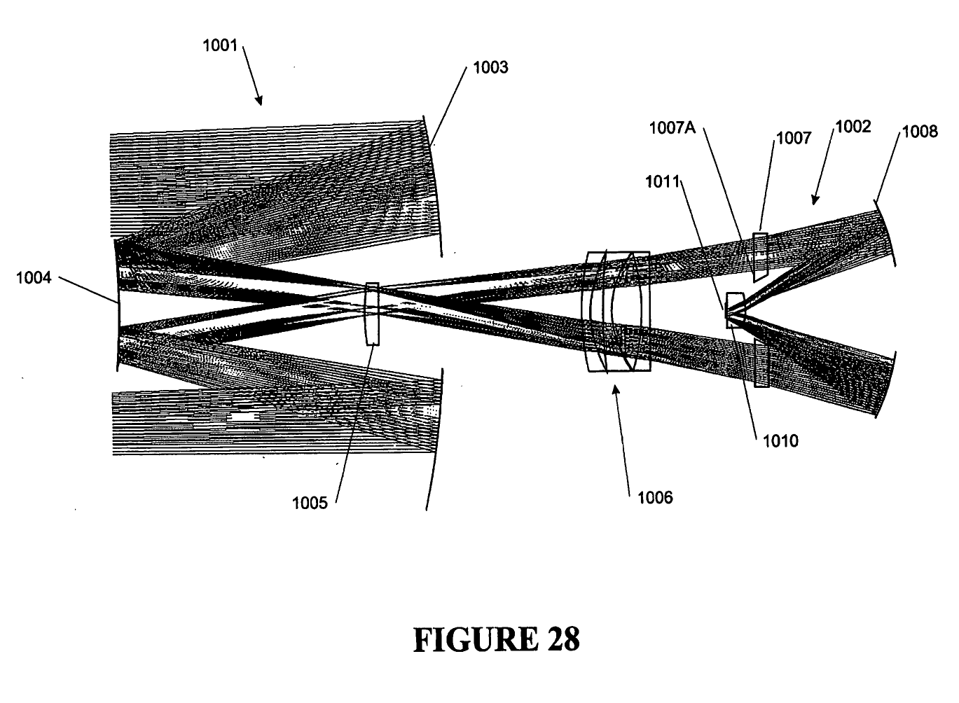

All of the above systems have a folding flat mirror in the relay. However, it should be noted that it is possible to remove the folding flat from the relay and allow the focus to be internal between the multiple component lens and the aspheric plate. An example of such a system is shown in FIG. 28, in which like reference numerals indicate like parts to FIG. 1, each reference numeral being increased by the addition of 1000. This system again has a Cassegrain-like front end 1001, but it will be appreciated that the front end need not be Cassegrain-like, and could again consist of a single mirror.

It will be noted that the rear end 1002 does not include a folding flat secondary mirror, but only has a concave primary mirror 1008. An aperture is provided in the aspheric plate 1007, and the converging light passes unmodified from the primary mirror 1008 to the field flattener 1010, and on to the detector 1011. The image data is extracted from the detector 1011 via a cable (not shown). In an alternative embodiment (not shown), the converging light may make a second pass through the previously unused part of the aspheric plate (ie no aperture is provided), and is received by a field flattener and detector in a similar position to that shown in FIG. 28. This would require re-optimisation of the system to achieve the desired performance.

All of the above systems include the combination of a meniscus and an aspheric plate as corrector elements. These elements can be arranged to substantially cancel each other's chromatic aberrations, whilst correcting for both primary and higher order spherical aberration in the optical imaging system. Further, the correctors can be used with a variety of front end and rear end combinations, and can be adapted for use with existing primary mirror or primary/secondary mirror pair front ends. The optical systems using this combination of corrector elements can be used for a variety of different purposes, due to the high image quality and low aberrations.

Although this invention has been described by way of example and with reference to possible embodiments thereof, it is to be understood that modifications or improvements may be made thereto without departing from the scope of the invention.

For example, while the systems of FIGS. 1, 5, 9, 12, 15, 18 and 28 all have Cassegrain-like (as hereinbefore defined) front ends, it is not essential to the functioning of the invention that the front end imaging system is Cassegrain-like, as will be apparent from reading the detailed description. For example, the secondary mirror need not be convex nor located so as to precede the focal plane of the primary. Rather, the secondary mirror could be concave or substantially flat, and only need be located so as to reflect light rearwards. The secondary mirror may precede the focal plane of the primary mirror, or may be located outside the primary mirror's focus. For example, the front end could include a concave secondary mirror located outside the primary mirror's focus (as is found in a Gregorian format) to transfer the image to the rear end relay. Further, systems using only a single mirror in the front end may be provided as shown in FIGS. 21, 22 and 25, for example. The important feature of the front end is that it forms an intermediate image.

1. An optical imaging system comprising:
a front end imaging system adapted to produce an intermediate image;
a rear end image relay system comprising a relay mirror;
an image transfer means adapted to image the aperture stop of the rear end image relay system to a position where it forms the entrance pupil of the optical imaging system;
and aberration correcting means comprising a lens having an aspheric surface located substantially at or adjacent to the aperture stop of the rear end image relay system and a meniscus lens to correct for both primary and higher order spherical aberration, the aspheric surface being sufficiently aspherical that chromatic error introduced by the lens having an aspheric surface cancels at least a major part of chromatic error introduced by the meniscus lens.

2. The optical system as claimed in claim 1, wherein the aspheric surface of the lens having an aspheric surface is sufficiently aspheric to cancel substantially all chromatic error introduced by the meniscus lens.

3. The optical system as claimed in claim 1, wherein the lens having an aspheric surface is a low- or zero-powered Schmidt-like lens.

4. The optical system as claimed in claim 3, wherein the depth of the aspheric surface of the Schmidt-like lens is greater than about 100 microns.

5. The optical system as claimed in claim 1, wherein the meniscus lens is a weak negative Maksutov-like meniscus lens.

6. The optical system as claimed in claim 1, wherein the aberration correcting means also comprises a multiple component lens adapted to also cancel chromatic error.

7. The optical system as claimed in claim 6, wherein the multiple component lens is a doublet lens.

8. The optical system as claimed in claim 7, wherein the doublet lens is fabricated from PK51 and KzFN2 glasses.

9. The optical system as claimed in claim 6, wherein the multiple component lens is a triplet lens.

10. The optical system as claimed in claim 9, wherein the triplet lens is fabricated from N-K5, N-KzFS4 and N-F2 glasses.

11. The optical system as claimed in claim 1, wherein the aberration correcting means is adapted to correct for zonal aberrations.

12. The optical system as claimed in claim 1, wherein the aberration correcting means is present in the rear end image relay system.

13. The optical system as claimed in claim 1, wherein the rear end image relay system includes comprises a secondary mirror adapted to receive light from the relay mirror.

14. The optical system as claimed in claim 13, wherein the relay mirror is a concave mirror and the secondary mirror is a folding flat mirror.

15. The optical system as claimed in claim 1, further comprising a detecting means to detect an image from the rear end image relay system.

16. The optical system as claimed in claim 15, wherein the detecting means comprises an electronic detector.

17. The optical system as claimed in claim 1, comprising a field flattener to adapt the image for detection by a planar detector.

18. The optical system as claimed in claim 1 wherein the front end imaging system comprises one or more mirrors.

19. The optical system as claimed in claim 18, wherein the front end imaging system comprises a concave primary mirror.

20. The optical system as claimed in claim 19, wherein the front end imaging system comprises a concave primary mirror and a secondary mirror located so as to reflect light received from the primary mirror.

21. The optical system as claimed in claim 1, comprising a housing and a window to seal the system from the surrounding environment.

22. The optical system as claimed in claim 21, wherein the window is a meniscus window.

23. The optical system as claimed in claim 21, wherein the front end imaging system comprises concave primary mirror and a secondary mirror located so as to reflect light received from the primary mirror, wherein the secondary mirror is formed by a reflective portion on one surface of the meniscus window.

24. The optical system as claimed in claim 21, wherein the front end imaging system comprises a concave primary mirror and a secondary mirror located so as to reflect light received from the primary mirror, wherein the secondary mirror is mounted to a surface of the window.

25. The optical system as claimed in claim 1, wherein the image transfer means is a field lens system.

26. The optical system as claimed in claim 25, wherein the field lens system comprises a single lens.

27. The optical system as claimed in claim 25, wherein the field lens system comprises a multiple component lens.

28. The optical system as claimed in claim 1, comprising a tilted mirror to deflect the focus of part of the optical system.

29. The optical system as claimed in claim 1, wherein the front end imaging system and the rear end image relay system are substantially complementary such that selected aberrations introduced into an image by the front end imaging system are at least partly cancelled by substantially like and opposite aberrations introduced by the rear end image relay.

30. The optical system as claimed in claim 29, wherein the front end imaging system and the rear end image relay are adapted so as to be substantially complementary in respect of selected aberrations over field angles up to approximately 2 degrees off-axis.

31. The optical system as claimed in claim 29, wherein the radii and separations of the optical system's mirrors are balanced against each other in such a way as to minimize monochromatic optical aberrations.

32. The optical system as claimed in claim 1, wherein the rear end image relay system is adapted to function as a high-speed optical relay.

33. The optical system as claimed in claim 1, wherein the front end imaging system is a spectrograph and the rear end is a high speed camera.

34. The optical system as claimed in claim 1, wherein all surfaces of the optical system's optical imaging components, except one, are substantially spherical.

35. The optical system as claimed in claim 1, wherein all optical components, except one, are sub-aperture components.

36. A method of imaging substantially parallel incident light onto a detecting means, the method comprising:
receiving incident light in a front end imaging system;
transferring the image from said front end imaging system to a rear end image relay system having a relay mirror and an aperture stop; and
receiving an image from the rear end image relay system by the detecting means;
wherein the step of transferring the image from said front end imaging system to the rear end image relay system comprises passing the light through an aberration correcting means comprising a lens having an aspheric surface located substantially at or adjacent to the aperture stop of the rear end image relay system and a meniscus lens to correct for both primary and higher order spherical aberration, the aspheric surface being sufficiently aspherical that chromatic error introduced by the lens having an aspheric surface cancels at least a major part of chromatic error introduced by the meniscus lens.

37. The method as claimed in claim 36, wherein the aspheric surface of the lens having an aspheric surface is sufficiently aspheric to cancel substantially all chromatic error introduced by the meniscus lens.

38. The method as claimed in claim 36, wherein the lens having an aspheric surface is a low- or zero-powered Schmidt-like lens.

39. The method as claimed in claim 38, wherein the depth of the aspheric surface of the Schmidt-like lens is greater than about 100 microns.

40. The method as claimed in claim 36, wherein the meniscus lens is a weak negative Maksutov-like meniscus lens.

41. The method as claimed in claim 36, wherein the aberration correcting means further comprises a multiple component lens adapted to also cancel chromatic error.

42. The method as claimed in claim 36, for selected aberrations, introducing like and opposite aberrations in the rear end image relay system to correct for aberrations introduced in the image by the front end imaging system.

43. The method as claimed in claim 42, wherein the method comprises introducing said like and opposite aberrations only in relation to field angles up to approximately 2 degrees off-axis.

44. The method as claimed in claim 36, comprising balancing the radii and separations of the imaging system's mirrors against each other in such a way as to minimise monochromatic aberration.

45. The method as claimed in claim 36 wherein the step of transferring the image from said front end imaging system to the rear end image relay system comprises imaging the entrance pupil of the front end imaging system onto the aperture stop of the rear end image relay system.

46. An optical imaging system comprising:
a front end imaging system adapted to produce an intermediate image;
a rear end image relay system comprising a relay mirror;
an image transfer means adapted to image the aperture stop of the rear end image relay system to a position where it forms the entrance pupil of the optical imaging system;
and aberration correcting means comprising a lens having an aspheric surface located substantially at or adjacent to the aperture stop of the rear end image relay system and a meniscus lens to correct for both primary and higher order spherical aberration, the aspheric surface being sufficiently aspherical that chromatic error introduced by the lens having an aspheric surface substantially cancels chromatic error introduced by the meniscus lens, the aberration correcting means further comprising a multiple component lens which is adapted to also cancel chromatic aberration.

47. The optical system as claimed in claim 14, wherein the front end imaging system is a Cassegrain-like system having a concave primary mirror and a convex secondary mirror.

48. The method as claimed in claim 36, wherein the front end imaging system is a Cassegrain-like system having a concave primary mirror and a convex secondary mirror and the rear end image relay system comprises a folding flat secondary mirror adapted to receive light from the relay mirror, and wherein the relay mirror is a concave mirror.

49. The optical imaging system as claimed in claim 46, wherein the front end imaging system is a Cassegrain-like system having a concave primary mirror and a convex secondary mirror and the rear end image relay system comprises a folding flat secondary mirror adapted to receive light from the relay mirror, and wherein the relay mirror is a concave mirror.
